(19) United States
(12) Patent Application Publication
(10) Pub. No.: US 2007/0285579 A1
(43) Pub. Date: Dec. 13, 2007

(54) Image processing apparatus, image processing method, program, and storage medium

(75) Inventors: Jun Hirai, Tokyo (JP); Makoto Tsukamoto, Kanagawa (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 11/799,694

(22) Filed: May 2, 2007

(30) Foreign Application Priority Data
May 11, 2006 (JP) P2006-132712

(51) Int. Cl. H04N 5/14

(52) U.S. Cl. 348/700

(57) ABSTRACT

An image processing apparatus includes a correlation computation unit configured to compute a phase correlation between image signals forming a plurality of images and a detection unit configured to detect a scene change on the basis of values of amplitudes in coordinate positions on the plurality of images, the values of amplitudes being obtained by computing the phase correlation.

### CROSS REFERENCES TO RELATED APPLICATIONS

The present invention contains subject matter related to Japanese Patent Application JP 2006-132712 filed in the Japanese Patent Office on May 11, 2006, the entire contents of which are incorporated herein by reference.

### BACKGROUND OF THE INVENTION

1. Field of the Invention

The present invention relates to image processing apparatuses, image processing methods, programs, and recording media, and, more particularly, to an image processing apparatus and an image processing method capable of accurately detecting a scene change, a program, and a recording medium.

2. Description of the Related Art

Currently, recording of received television broadcast signals on a mass storage medium such as a hard disk is often performed. In such a case, in order to allow users to retrieve a desired moving image quickly, a technique for displaying representative images of individual scenes as thumbnail images is known. In order to detect the representative images of individual scenes, scene change frames (hereinafter also referred to as scene changes) functioning as boundaries between scenes are required to be detected.

In Japanese Unexamined Patent Application Publication No. 2003-299000, a scene change detecting method is disclosed. First, calculation of a value of a difference between information on an image forming a frame and information on an image forming a preceding frame is performed upon a predetermined number of consecutive frames in a moving image. Subsequently, the variance of these calculated difference values is calculated. Using the calculated variance, the deviation of the difference value of a certain frame included in the above-described predetermined number of frames is calculated. When the deviation is larger than a threshold value, the certain frame is determined to be a scene change frame.

However, in the case of the method disclosed in Japanese Unexamined Patent Application Publication No. 2003-299000, when only brightness of an image forming a frame that is not a scene change frame is changed, the frame may be falsely detected as a scene change frame.

It is desirable to more accurately detect a scene change.

### SUMMARY OF THE INVENTION

An image processing apparatus according to an embodiment of the present invention includes: a correlation computation unit configured to compute a phase correlation between image signals forming a plurality of images; and a detection unit configured to detect a scene change on the basis of values of amplitudes in coordinate positions on the images, the values of amplitudes being obtained by computing the phase correlation.

The correlation computation unit can perform computation compliant with SPOMF.

The correlation computation unit can include: a Fourier transform unit configured to perform Fourier transforms upon the image signals forming the images; a cross power spectrum computation unit configured to compute a cross power spectrum using values obtained by performing the Fourier transforms; and an inverse Fourier transform unit configured to perform an inverse Fourier transform upon the computed cross power spectrum.

The detection unit can include: a counter unit configured to count the number of amplitudes; and a determination unit configured to perform determination of a scene change if the number of amplitudes is larger than a reference value.

The detection unit can further include a normalization unit configured to normalize the values of amplitudes. The counter unit can count the number of normalized amplitudes.

The image processing apparatus according to an embodiment of the present invention can further include an extraction unit configured to extract image signals corresponding to regions that are portions of the images from the image signals forming the images. The correlation computation unit can compute a phase correlation between the extracted image signals corresponding to the regions.

The image processing apparatus according to an embodiment of the present invention can further include a reducing unit configured to generate image signals by reducing sizes of the regions that are portions of the extracted image signals. The correlation computation unit can compute a phase correlation between the generated image signals corresponding to the size-reduced regions.

The image processing apparatus according to an embodiment of the present invention can further include a non-image detection unit configured to detect image signals forming non-images from the image signals forming the plurality of images. The correlation computation unit can perform computation if the image signals forming the images are not image signals forming non-images.

The non-image detection unit can include: a Fourier transform unit configured to perform Fourier transforms upon the image signals forming the images; an alternating component detection unit configured to detect alternating components from the Fourier-transformed image signals; and a control unit configured to interrupt computation of the correlation computation unit when values of the detected alternating components are smaller than an alternating component threshold value.

The image processing apparatus according to an embodiment of the present invention can further include a difference computation unit configured to compute a difference between the image signals forming the images. The correlation computation unit can perform computation when the computed difference is larger than a difference threshold value.

The image processing apparatus according to an embodiment of the present invention can further include a dividing unit configured to divide each of the image signals forming the images so as to generate image signals corresponding to portions obtained by dividing a single image into the portions. The correlation computation unit can compute phase correlations between corresponding image signals generated by dividing each of the image signals forming the images.

The image processing apparatus according to an embodiment of the present invention can further include a representative image detection unit configured to detect a representative image using a result of computation performed by the correlation computation unit.

The representative image detection unit can detect an image corresponding to a motion vector having the minimum value as a representative image, the motion vector being obtained as a result of commutation performed by the correlation computation unit.

The image processing apparatus according to an embodiment of the present invention can further include: a Fourier transform unit configured to perform Fourier transforms upon the image signals forming the images; an amplitude spectrum computation unit configured to compute amplitude spectrums of the Fourier-transformed image signals; a coordinate transformation unit configured to transform the amplitude spectrums into log-polar coordinates; and a transformation unit configured to compute a phase correlation between signals obtained by the log-polar coordinate transformation, and perform transformation processing for image rotation or image scaling on the basis of the computed phase correlation. The correlation computation unit can compute a phase correlation using an image signal obtained by performing the transformation processing.

An image processing method or a program according to an embodiment of the present invention includes the steps of: computing a phase correlation between image signals forming a plurality of images; and detecting a scene change on the basis of values of amplitudes in coordinate positions on the images, the values of amplitudes being obtained by computing the phase correlation.

The program according to an embodiment of the present invention can be recorded on a recording medium.

An image processing apparatus according to another embodiment of the present invention includes: an average computation unit configured to compute an average for each of image signals forming a plurality of images; a difference computation unit configured to compute differences between values of the image signals forming the images and the computed corresponding averages; a matching unit configured to perform matching of the computed differences; and a detection unit configured to detect a scene change on the basis of values of amplitudes in coordinate positions on the images, the values of amplitudes being obtained by performing the matching.

The image processing apparatus according to another embodiment of the present invention can further include an extraction unit configured to extract image signals corresponding to regions that are portions of the images from the image signals forming the images. The average computation unit can compute the average for each of the extracted image signals corresponding to the regions.

The image processing apparatus according to another embodiment of the present invention can further include a reducing unit configured to generate image signals by reducing sizes of the regions that are portions of the extracted image signals. The average computation unit can compute the average for each of the generated image signals corresponding to the size-reduced regions.

An image processing method or a program according to another embodiment of the present invention includes the steps of: computing an average for each of image signals forming a plurality of images; computing differences between values of the image signals forming the images and the computed corresponding averages; performing matching of the computed differences; and detecting a scene change on the basis of values of amplitudes in coordinate positions on the images, the values of amplitudes being obtained by performing the matching.

The program according to another embodiment of the present invention can be recorded on a recording medium.

According to an embodiment of the present invention, a phase correlation between image signals forming a plurality of images is computed, and a scene change is detected on the basis of values of amplitudes in coordinate positions on the images, the values of amplitudes being obtained by computing the phase correlation.

According to another embodiment of the present invention, computation of an average is performed for each of image signals forming a plurality of images, differences between values of the image signals forming the images and the computed corresponding averages is computed, matching of the computed differences is performed, and a scene change is detected on the basis of values of amplitudes in coordinate positions on the images, the values of amplitudes being obtained by performing the matching.

Thus, according to an embodiment of the present invention, a scene change can be more accurately detected.

Similarly, according to another embodiment of the present invention, a scene change can be more accurately detected.

### BRIEF DESCRIPTION OF THE DRAWINGS

FIG. 1 is a block diagram showing a configuration of an image processing apparatus according to an embodiment of the present invention;

FIG. 2 is a flowchart describing scene change detection performed by the image processing apparatus shown in FIG. 1;

FIG. 3 is a flowchart showing scene change detection performed by the image processing apparatus shown in FIG. 1;

FIG. 4 is a diagram describing region extraction processing performed in step S2 shown in FIG. 2;

FIG. 5 is a diagram showing image reducing processing performed in step S3 shown in FIG. 2;

FIG. 6 is a diagram showing image reducing processing performed in step S3 shown in FIG. 2;

FIG. 7 is a diagram showing image reducing processing performed in step S3 shown in FIG. 2;

FIG. 8 is a diagram showing an exemplary result of computation compliant with SPOMF when a scene change is detected;

FIG. 9 is a diagram showing an exemplary result of computation compliant with SPOMF when an image that is not a scene change is detected;

FIG. 10 is a block diagram showing a configuration of an image processing apparatus according to another embodiment of the present invention;

FIG. 11 is a flowchart describing scene change detection performed by the image processing apparatus shown in FIG. 10;

FIG. 12 is a flowchart describing scene change detection performed by the image processing apparatus shown in FIG. 10;

FIG. 13 is a block diagram showing a configuration of an image processing apparatus according to another embodiment of the present invention;

FIG. 14 is a flowchart describing scene change detection performed by the image processing apparatus shown in FIG. 13;

FIG. 15 is a flowchart describing scene change detection performed by the image processing apparatus shown in FIG. 13;

FIG. 16 is a block diagram showing a configuration of an image processing apparatus according to another embodiment of the present invention;

FIG. 17 is a block diagram showing a configuration of an image processing apparatus according to another embodiment of the present invention;

FIG. 18 is a diagram describing image division processing;

FIG. 19 is a flowchart describing scene change detection performed by the image processing apparatus shown in FIG. 17;

FIG. 20 is a flowchart describing scene change detection performed by the image processing apparatus shown in FIG. 17;

FIG. 21 is a block diagram showing a configuration of an image processing apparatus according to another embodiment of the present invention;

FIG. 22 is a flowchart describing scene change detection and representative image detection performed by the image processing apparatus shown in FIG. 21;

FIG. 23 is a flowchart describing scene change detection and representative image detection performed by the image processing apparatus shown in FIG. 21;

FIG. 24 is a block diagram showing a configuration of an image processing apparatus according to another embodiment of the present invention;

FIG. 25 is a block diagram showing a configuration of an image processing apparatus according to another embodiment of the present invention;

FIG. 26 is a flowchart describing scene change detection and representative image detection performed by the image processing apparatus shown in FIG. 25;

FIG. 27 is a flowchart describing scene change detection and representative image detection performed by the image processing apparatus shown in FIG. 25;

FIG. 28 is a flowchart describing scene change detection and representative image detection performed by the image processing apparatus shown in FIG. 25;

FIG. 29 is a block diagram showing a configuration of an image processing apparatus according to another embodiment of the present invention;

FIG. 30 is a flowchart describing scene change detection performed by the image processing apparatus shown in FIG. 29;

FIG. 31 is a flowchart describing scene change detection performed by the image processing apparatus shown in FIG. 29;

FIG. 32 is a block diagram showing a configuration of an image processing apparatus according to another embodiment of the present invention;

FIG. 33 is a flowchart describing scene change detection performed by the image processing apparatus shown in FIG. 32;

FIG. 34 is a flowchart describing scene change detection performed by the image processing apparatus shown in FIG. 32; and

FIG. 35 is a block diagram showing a configuration of a personal computer according to an embodiment of the present invention.

### DESCRIPTION OF THE PREFERRED EMBODIMENTS

Before describing embodiments of the present invention, the correspondence between the features of the present invention and embodiments of the present invention disclosed in this specification or the accompanying drawings is discussed below. This description is intended to assure that embodiments supporting the present invention are described in this specification or the accompanying drawings. Thus, even if an embodiment in this specification or the accompanying drawings is not described as relating to a certain feature of the present invention, that does not necessarily mean that the embodiment does not relate to that feature of the present invention. Conversely, even if an embodiment is described herein as relating to a certain feature of the present invention, that does not necessarily mean that the embodiment does not relate to other features of the present invention.

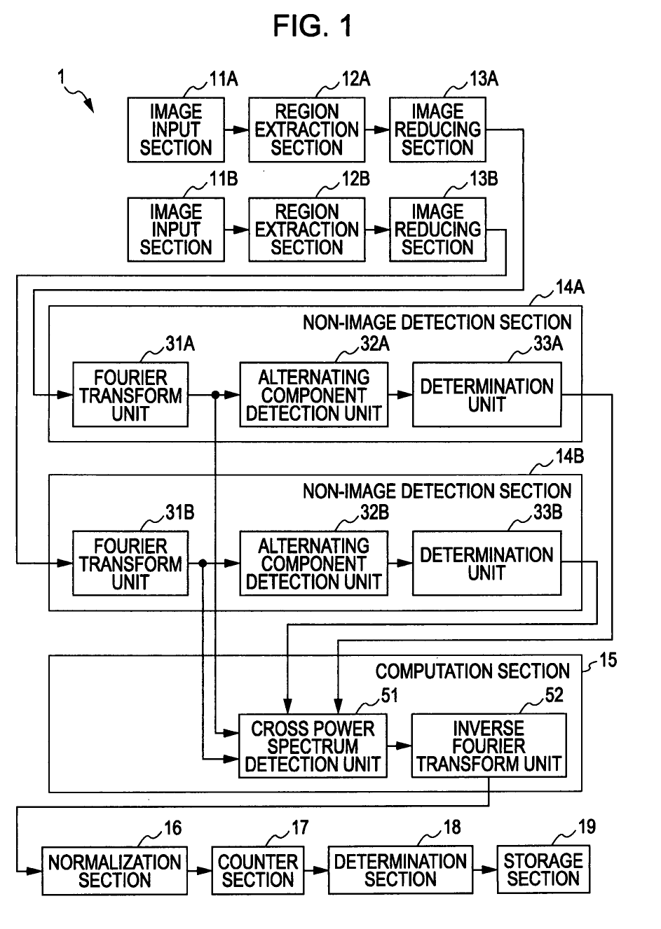

An image processing apparatus (for example, an image processing apparatus 1 shown in FIG. 1) according to an embodiment of the present invention includes: a correlation computation unit (for example, a computation section 15 shown in FIG. 1) configured to compute a phase correlation between image signals forming a plurality of images; and a detection unit (for example, a counter section 17 and a determination section 18 shown in FIG. 1) configured to detect a scene change on the basis of values of amplitudes in coordinate positions on the images, the values of amplitudes being obtained by computing the phase correlation.

The correlation computation unit can include: a Fourier transform unit (for example, Fourier transform units 31A and 31B shown in FIG. 1) configured to perform Fourier transforms upon the image signals forming the images; a cross power spectrum computation unit (for example, a cross power spectrum detection unit 51 shown in FIG. 1) configured to compute a cross power spectrum using values obtained by performing the Fourier transforms; and an inverse Fourier transform unit (for example, an inverse Fourier transform unit 52 shown in FIG. 1) configured to perform an inverse Fourier transform upon the computed cross power spectrum.

The detection unit can include: a counter unit (for example, the counter section 17 shown in FIG. 1) configured to count the number of amplitudes; and a determination unit (for example, the determination section 18 shown in FIG. 1) configured to perform determination of a scene change if the number of amplitudes is larger than a reference value.

The detection unit can further include a normalization unit (for example, a normalization section 16 shown in FIG. 1) configured to normalize the values of amplitudes. The counter unit can count the number of normalized amplitudes.

The image processing apparatus according to an embodiment of the present invention can further include an extraction unit (for example, region extraction sections 12A and 12B shown in FIG. 1) configured to extract image signals corresponding to regions that are portions of the images from the image signals forming the images. The correlation computation unit can compute a phase correlation between the extracted image signals corresponding to the regions.

The image processing apparatus according to an embodiment of the present invention can further include a reducing unit (for example, image reducing sections 13A and 13B shown in FIG. 1) configured to generate image signals by reducing sizes of the regions that are portions of the extracted image signals. The correlation computation unit can compute a phase correlation between the generated image signals corresponding to the size-reduced regions.

The image processing apparatus according to an embodiment of the present invention can further include a non-image detection unit (for example, non-image detection sections 14A and 14B shown in FIG. 1) configured to detect image signals forming non-images from the image signals forming the plurality of images. The correlation computation unit can perform computation if the image signals forming the images are not image signals forming non-images.

The non-image detection unit can include: a Fourier transform unit (for example, the Fourier transform units 31A and 31B shown in FIG. 1) configured to perform Fourier transforms upon the image signals forming the images; an alternating component detection unit (for example, alternating component detection units 32A and 32B shown in FIG. 1) configured to detect alternating components from the Fourier-transformed image signals; and a control unit (for example, determination units 33A and 33B shown in FIG. 1) configured to interrupt computation of the correlation computation unit when values of the detected alternating components are smaller than an alternating component threshold value.

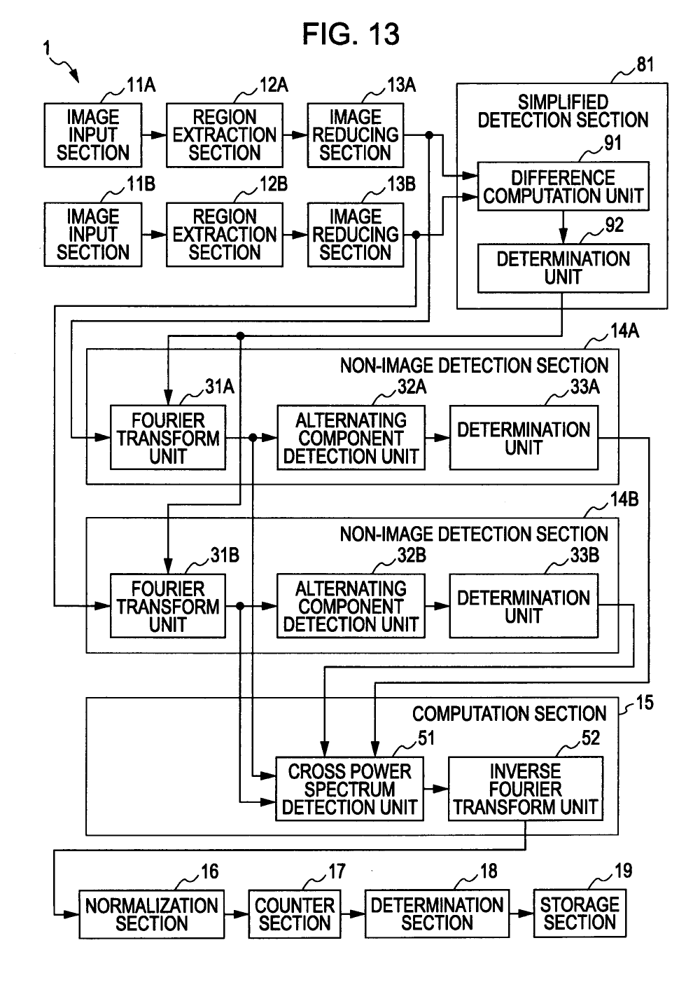

The image processing apparatus according to an embodiment of the present invention can further include a difference computation unit (for example, a difference computation unit 91 shown in FIG. 13) configured to compute a difference between the image signals forming the images. The correlation computation unit can perform computation when the computed difference is larger than a difference threshold value.

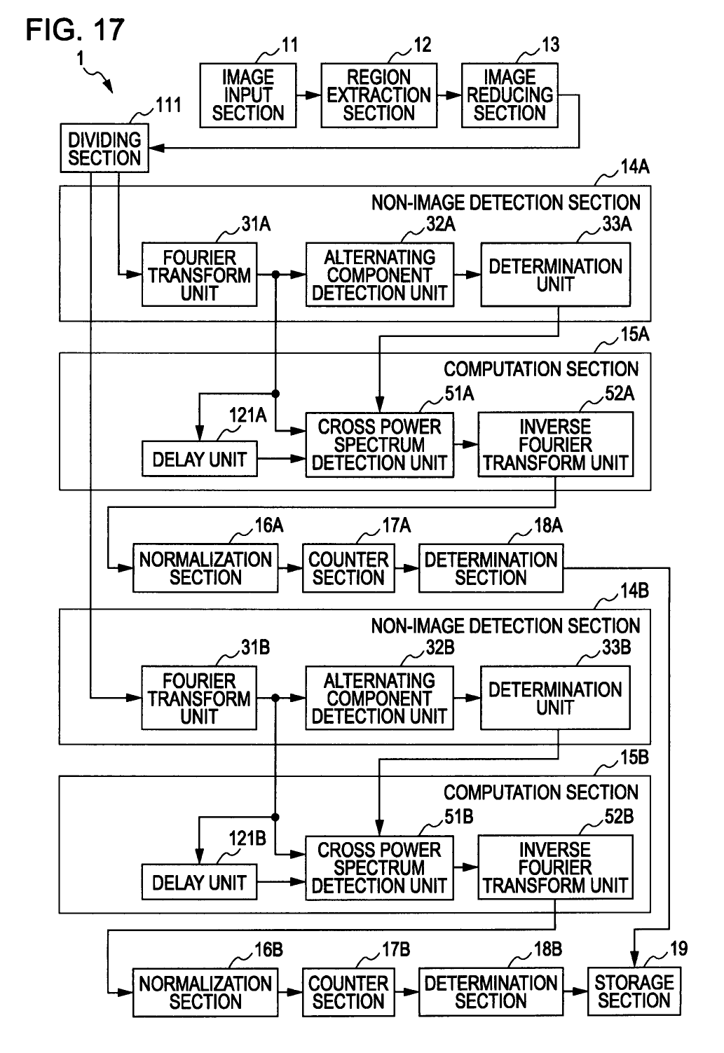

The image processing apparatus according to an embodiment of the present invention can further include a dividing unit (for example, a dividing section 111 shown in FIG. 17) configured to divide each of the image signals forming the images so as to generate image signals corresponding to portions obtained by dividing a single image into the portions. The correlation computation unit can compute phase correlations between corresponding image signals generated by dividing each of the image signals forming the images.

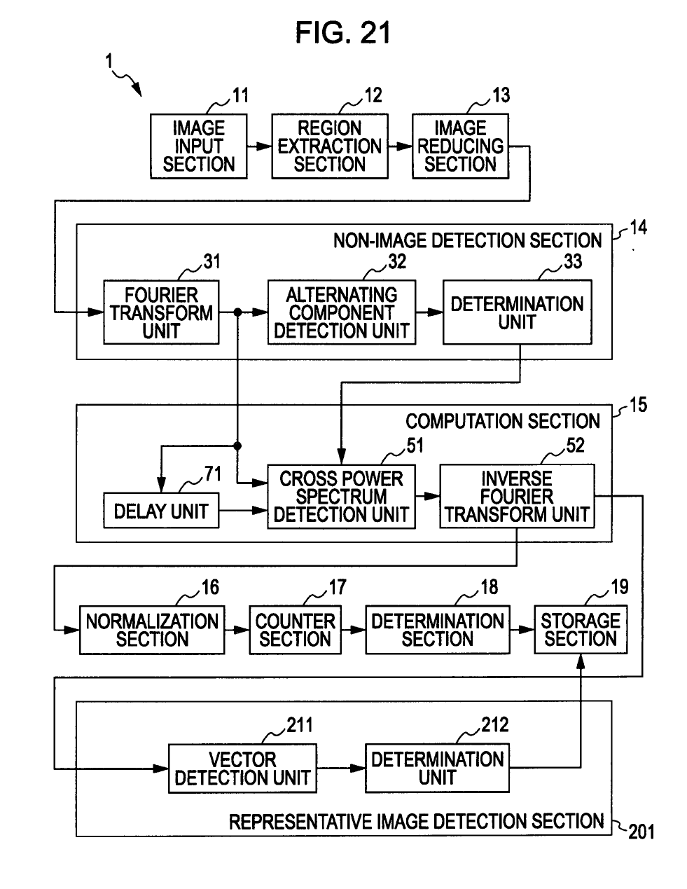

The image processing apparatus according to an embodiment of the present invention can further include a representative image detection unit (for example, a representative image detection section 201 shown in FIG. 21) configured to detect a representative image using a result of computation performed by the correlation computation unit.

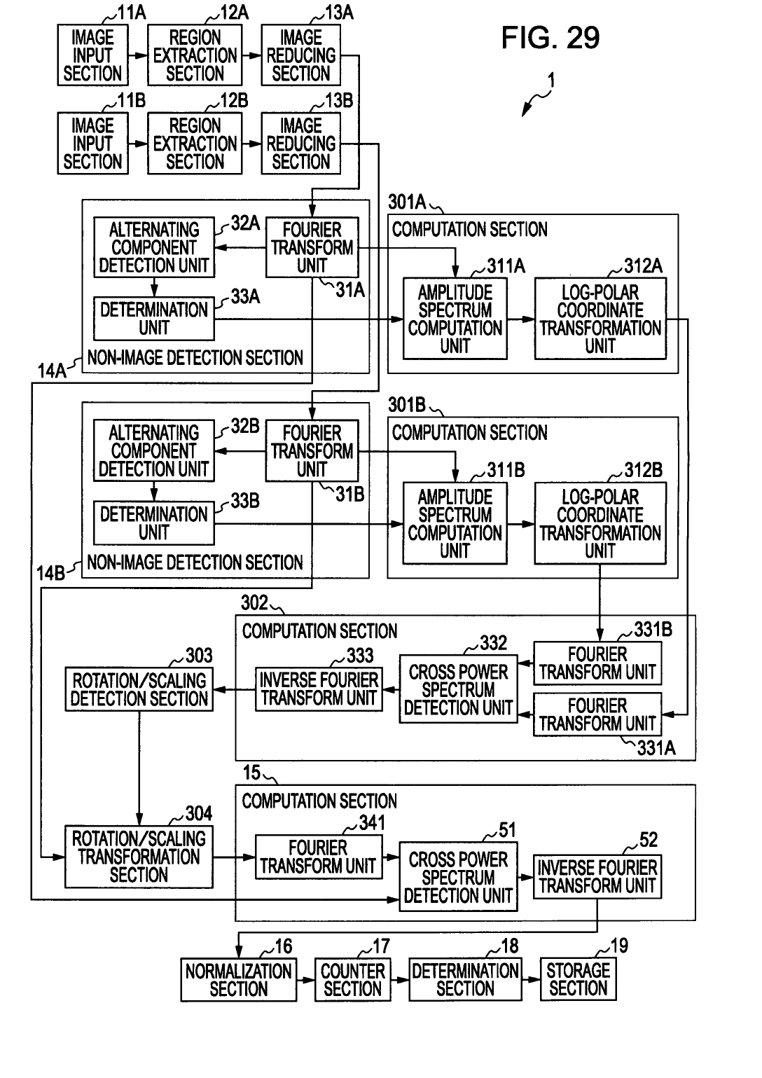

The image processing apparatus according to an embodiment of the present invention can further include: a Fourier transform unit (for example, the Fourier transform units 31A and 31B shown in FIG. 29) configured to perform Fourier transforms upon the image signals forming the images; an amplitude spectrum computation unit (for example, amplitude spectrum computation units 311A and 311B shown in FIG. 29) configured to compute amplitude spectrums of the Fourier-transformed image signals; a coordinate transformation unit (for example, log-polar coordinate transformation units 312A and 312B shown in FIG. 29) configured to transform the amplitude spectrums into log-polar coordinates; and a transformation unit (for example, a rotation/scaling transformation section 304 shown in FIG. 29) configured to compute a phase correlation between signals obtained by the log-polar coordinate transformation, and perform transformation processing for image rotation or image scaling on the basis of the computed phase correlation. The correlation computation unit can compute a phase correlation using an image signal obtained by performing the transformation processing.

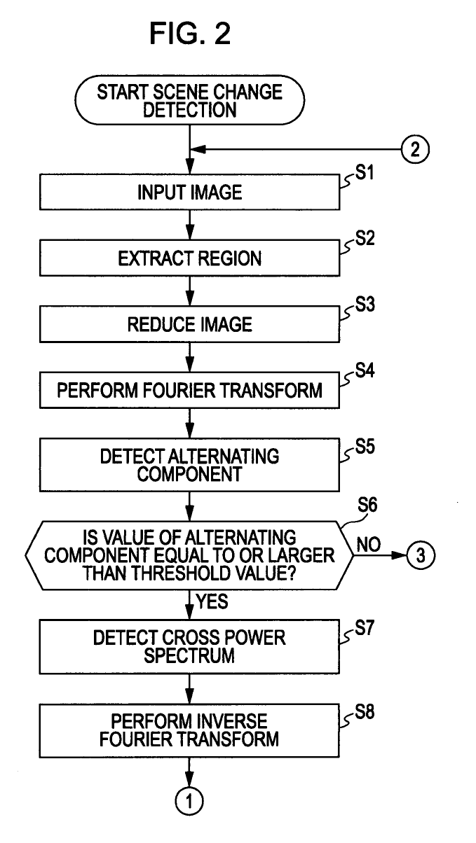

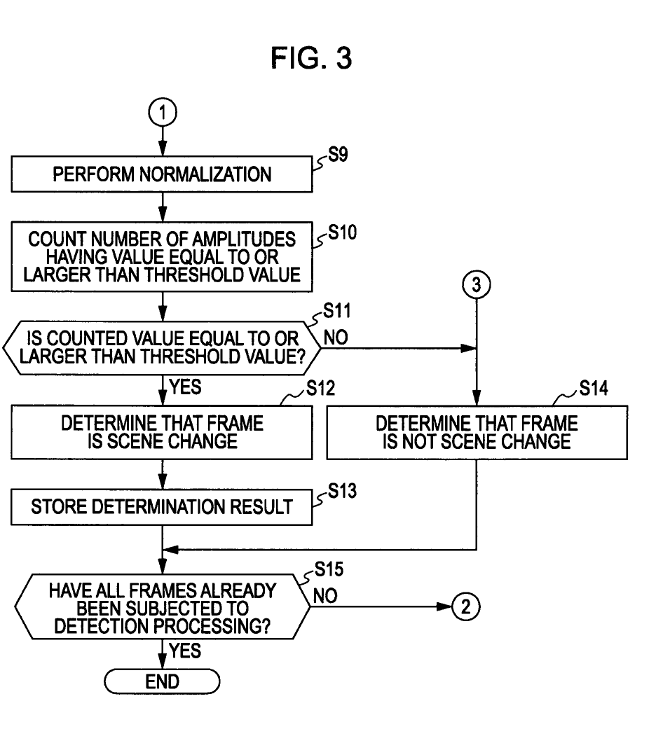

An image processing method or a program according to an embodiment of the present invention includes the steps of: computing a phase correlation between image signals forming a plurality of images (for example step S7 shown in FIG. 2 to step S9 shown in FIG. 3); and detecting a scene change on the basis of values of amplitudes in coordinate positions on the images, the values of amplitudes being obtained by computing the phase correlation (for example, step S10 to step S14 shown in FIG. 3).

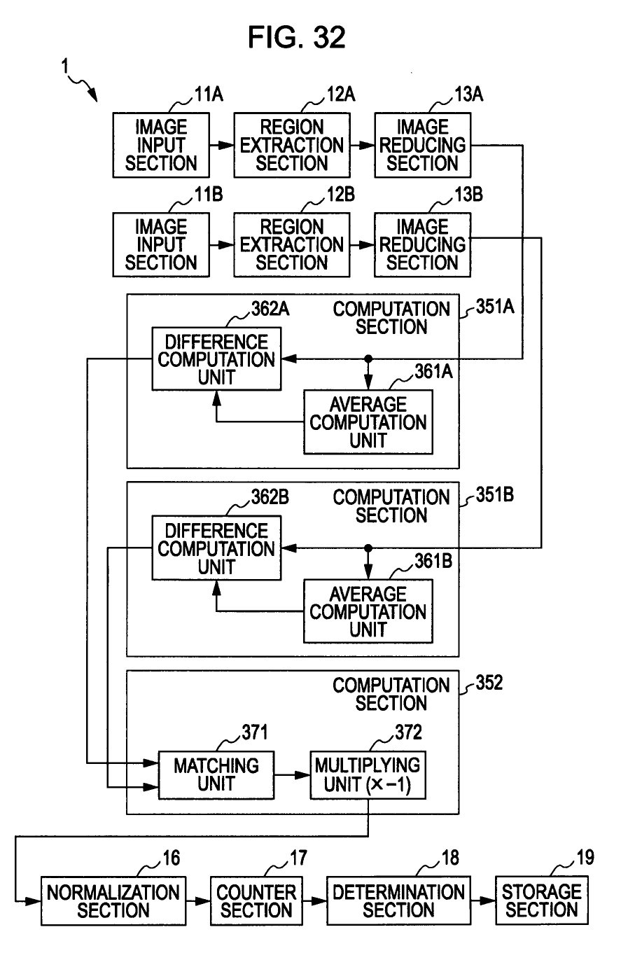

An image processing apparatus (for example, the image processing apparatus 1 shown in FIG. 32) according to another embodiment of the present invention includes: an average computation unit (for example, average computation units 361A and 361B shown in FIG. 32) configured to compute an average for each of image signals forming a plurality of images; a difference computation unit (for example, difference computation units 362A and 362B shown in FIG. 32) configured to compute differences between values of the image signals forming the images and the computed corresponding averages; a matching unit (for example, a matching unit 371 shown in FIG. 32) configured to perform matching of the computed differences; and a detection unit (for example, the counter section 17 and the determination section 18 shown in FIG. 32) configured to detect a scene change on the basis of values of amplitudes in coordinate positions on the images, the values of amplitudes being obtained by performing the matching.

The image processing apparatus according to another embodiment of the present invention can further include an extraction unit (for example, the region extraction sections 12A and 12B shown in FIG. 32) configured to extract image signals corresponding to regions that are portions of the images from the image signals forming the images. The average computation unit can compute the average for each of the extracted image signals corresponding to the regions.

The image processing apparatus according to another embodiment of the present invention can further include a reducing unit (for example, the image reducing sections 13A and 13B shown in FIG. 32) configured to generate image signals by reducing sizes of the regions that are portions of the extracted image signals. The average computation unit can compute the average for each of the generated image signals corresponding to the size-reduced regions.

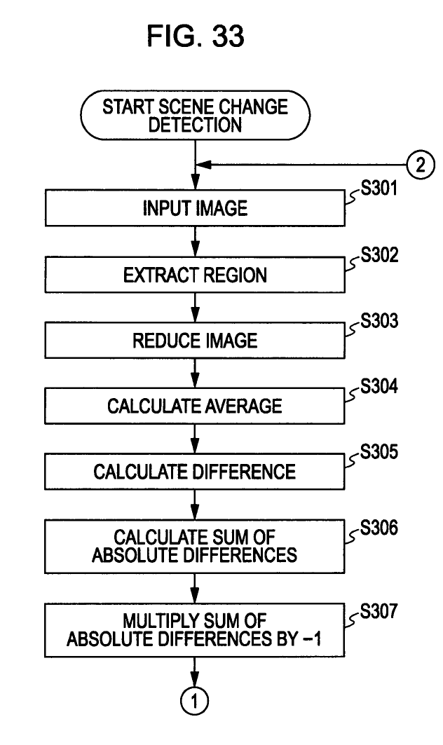

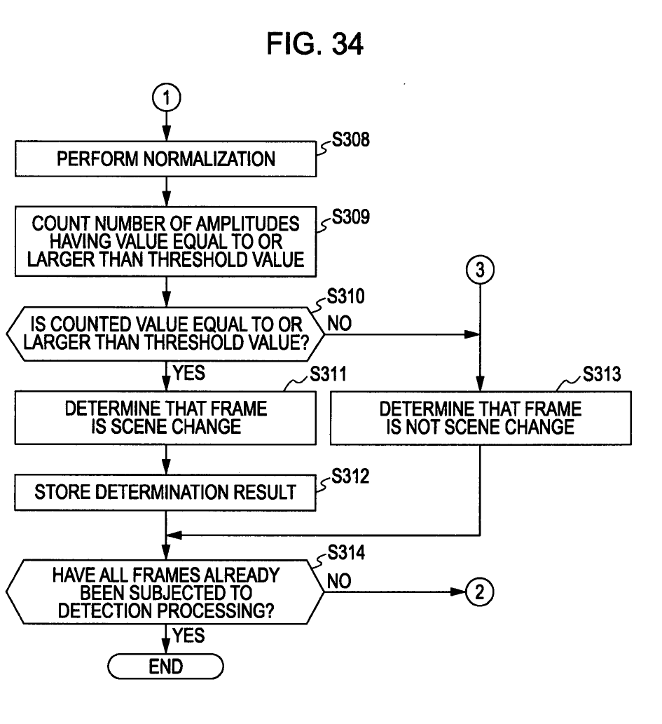

An image processing method or a program according to another embodiment of the present invention includes the steps of: computing an average for each of image signals forming a plurality of images (for example, step S304 shown in FIG. 33); computing differences between values of the image signals forming the images and the computed corresponding averages (for example, step S305 shown in FIG. 33); performing matching of the computed differences (for example, step S306 shown in FIG. 33); and detecting a scene change on the basis of values of amplitudes in coordinate positions on the images, the values of amplitudes being obtained by performing the matching (for example, step S309 to step S313 shown in FIG. 34).

Embodiments of the present invention will be described with reference to the accompanying drawings.

FIG. 1 shows a configuration of an image processing apparatus according to an embodiment of the present invention.

An image processing apparatus 1 is provided with image input sections 11A and 11B, the region extraction sections 12A and 12B, the image reducing sections 13A and 13B, the non-image detection sections 14A and 14B, the computation section 15, the normalization section 16, the counter section 17, the determination section 18, and a storage section 19.

The image input section 11A is configured with, for example, a tuner, and receives a television broadcast signal and outputs the received signal to the region extraction section 12A. The region extraction section 12A extracts an image signal corresponding to a predetermined region of a single image represented by the received image signal. The image reducing section 13A reduces the size of the predetermined region represented by the image signal extracted by the region extraction section 12A by reducing the number of pixels included in the predetermined region. The image signal corresponding to the size-reduced region reduced by the image reducing section 13A is supplied to the non-image detection section 14A.

The image input section 11B, the region extraction section 12B, and the image reducing section 13B perform the same processing as the image input section 11A, the region extraction section 12A, and the image reducing section 13A, respectively, upon different images. The image input section 11B may be removed, and the output of the image input section 11A may be supplied to the region extraction section 12B.

The non-image detection sections 14A and 14B detect an image that can hardly be defined as an image (hereinafter referred to as a non-image) such as a white overexposed image obtained after a flash has been fired. The non-image detection section 14A is provided with the Fourier transform unit 31A, the alternating component detection unit 32A, and the determination unit 33A. The non-image detection section 14B is similarly provided with the Fourier transform unit 31B, the alternating component detection unit 32B, and the determination unit 33B.

The Fourier transform unit 31A performs a fast Fourier transform upon the image signal transmitted from the image reducing section 13A, and outputs the processed image signal to the alternating component detection unit 32A. The alternating component detection unit 32A detects an alternating component from the image signal transmitted from the Fourier transform unit 31A. The determination unit 33A compares the value of the alternating component detected by the alternating component detection unit 32A with a predetermined threshold value that has been set in advance, determines whether an image represented by the received image signal is a non-image on the basis of the comparison result, and then controls the operation of the cross power spectrum detection unit 51 on the basis of the determination result.

The Fourier transform unit 31B, the alternating component detection unit 32B, and the determination unit 33B, which are included in the non-image detection section 14B, perform the same processing as the Fourier transform unit 31A, the alternating component detection unit 32A, and the determination unit 33A, respectively, which are included in the non-image detection section 14A, upon the output of the image reducing section 13B. Subsequently, the operation of the cross power spectrum detection unit 51 is controlled on the basis of the determination result of the determination unit 33B.

The computation section 15 performs computation compliant with SPOMF (Symmetrical Phase-Only Matched Filtering). SPOMF is described in “Symmetric Phase-Only Matched Filtering of Fourier-Mellin Transforms for Image Registration and Recognition”, IEEE Transaction on Pattern Analysis and Machine Intelligence, VOL. 16, No. 12, December 1994.

The computation section 15 is provided with the cross power spectrum detection unit 51 and the inverse Fourier transform unit 52. However, the Fourier transform units 31A and 31B included in the non-image detection sections 14A and 14B configure a portion of the computation section 15 in reality. That is, the Fourier transform units 31A and 31B in the non-image detection sections 14A and 14B serve as a Fourier transform unit of the computation section 15. A dedicated Fourier transform unit may be disposed in the computation section 15.

The cross power spectrum detection unit 51 computes a cross power spectrum using the outputs of the Fourier transform units 31A and 31B. The operation of the cross power spectrum detection unit 51 is controlled on the basis of the outputs of the determination units 33A and 33B. That is, if the determination unit 33A or 33B determines that an image being processed is a non-image, the operation of the cross power spectrum detection unit 51 is interrupted. The inverse Fourier transform unit 52 performs a fast inverse Fourier transform upon the output of the cross power spectrum detection unit 51.

The normalization section 16 normalizes the output of the inverse Fourier transform unit 52. The counter section 17 detects the number of peaks of the output of the normalization section 16, and outputs the detection result to the determination section 18. The determination section 18 compares the detected number of peaks with a predetermined reference value that has been set in advance, and outputs the comparison result to the storage section 19 so as to cause the storage section 19 to store the comparison result. The image signals output from the image input sections 11A and 11B are also stored in the storage section 19.

Scene change detection performed by the image processing apparatus 1 shown in FIG. 1 will be described with reference to flowcharts shown in FIGS. 2 and 3.

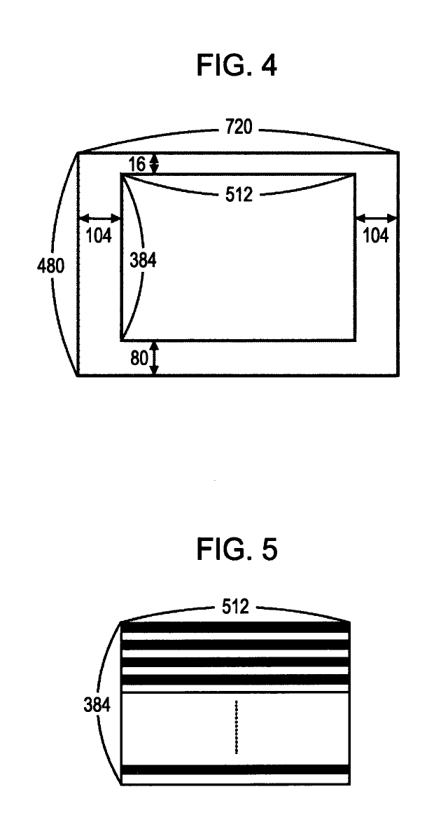

In step S1, the image input sections 11A and 11B receive images forming different frames. The region extraction sections 12A and 12B extract image signals corresponding to predetermined regions of the images received by the image input sections 11A and 11B, respectively. More specifically, as shown in FIG. 4, when the size of a single image is 720×480 pixels, an outer region extending 16 pixels from the top of the image, 80 pixels from the bottom thereof, and 104 pixels from the left and right ends thereof is removed and an inner region of 512×384 pixels is extracted. Telop characters are often displayed in an outer region of an image. When an image forming a telop and an image forming a frame pattern on the border of an image are used to detect a scene change, false detection can be prevented by removing an image signal corresponding to such an outer region.

Pixel values of pixels outside of the extracted inner region are not set to zero, and are set so that they are smoothly changed from the boundary of the inner region toward the outside thereof like a cross-fade. Consequently, the effect of a spectrum on the border can be reduced.

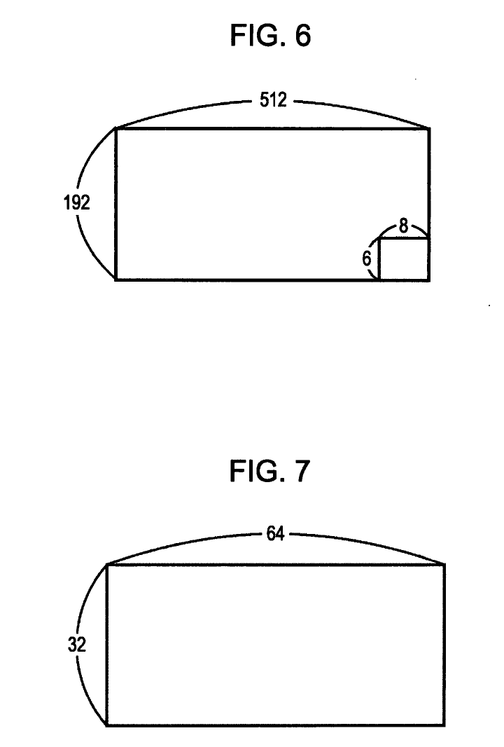

Next, in step S3, the image reducing sections 13A and 13B reduce the sizes of the regions represented by the image signals transmitted from the region extraction sections 12A and 12B, respectively. More specifically, as shown in FIG. 5, when the extracted region of 512×384 pixels is compliant with the interlace format, an image corresponding to one of two fields is selected. As shown in FIG. 6, the selected image is, for example, an image of 512×192 pixels. The image of 512×192 pixels is divided into blocks each of which is composed of 8×6 pixels, and then the average pixel values of pixels included in individual blocks are calculated. Subsequently, as shown in FIG. 7, a reduced-size image of 64×32 pixels is generated using these average pixel values.

Thus, by significantly reducing the number of pixels, the amount of computation to be performed can be reduced. Since pixel values of pixels included in individual blocks are averaged, the correlation between frames has to be examined using grainy images. Generally, when the rotation of an image is performed between frames, the level of the correlation between them is lowered. It is therefore sometimes falsely detected that one of the frames is a scene change. However, in a case where the correlation between frames is examined using grainy images, the level of the correlation is not lowered even if the rotation of an image is performed between them. Accordingly, the false detection of a scene change can be prevented.

Next, in step S4, the Fourier transform unit 31A performs a two-dimensional fast Fourier transform upon the image signal transmitted from the image reducing section 13A. More specifically, the computation represented by the following equation (1) is performed. Similarly, the Fourier transform unit 31B performs a two-dimensional fast Fourier transform using the following equation (2).

$$\begin{matrix}F ( {f}_{x} , {f}_{y} ) = {\int }_{- ∞}^{+ ∞} {\int }_{- ∞}^{+ ∞} f ( x , y ) {e}^{- 2 π j ( {f}_{x} x + {f}_{y} y )} d x d y & ( 1 ) \\ G ( {f}_{x} , {f}_{y} ) = {\int }_{- ∞}^{+ ∞} {\int }_{- ∞}^{+ ∞} g ( x , y ) {e}^{- 2 π j ( {f}_{x} x + {f}_{y} y )} d x d y & ( 2 )\end{matrix}$$

In step S5, the alternating component detection unit 32A detects an alternating component from the output of the Fourier transform unit 31A. Similarly, the alternating component detection unit 32B detects an alternating component from the output of the Fourier transform unit 31B. In step S6, the determination units 33A and 33B compare the detection results of the alternating component detection units 32A and 32B with a predetermined threshold value that has been set in advance to determine whether the values of the detected alternating components are equal to or larger than the threshold value.

If one of the images forming different frames extracted by the region extraction sections 12A and 12B is a white overexposed image, that is, a non-image, and if the other one of the images is a normal image, it is often determined that there is no correlation between these images (that is, the white overexposed image is a scene change). However, in such a case, the white overexposed image is not a scene change in reality, and is simply displayed as a bright image due to light emitted by a flash. Accordingly, it is not desirable that such a frame be detected to be a scene change. In the case of a white overexposed image due to light emitted by a flash, the value of the alternating component represented by a coefficient used in a fast Fourier transform is small. Accordingly, if the values of the alternating components are smaller than the threshold value that has been set in advance, the determination units 33A and 33B determine that the frames being processed are not scene changes is step S14. Thus, a white overexposed image can be prevented from being falsely detected as a scene change.

Next, in step S15, the determination units 33A and 33B determine whether all frames have already been subjected to detection processing. If all frames have not yet been subjected to detection processing, the process returns to step S1 and then the process from step S1 to the subsequent steps is repeatedly performed.

If it is determined in step S6 that the values of the alternating components are equal to or larger than the threshold value, the cross power spectrum detection unit 51 detects a cross power spectrum in step S7. More specifically, the cross power spectrum detection unit 51 computes a cross power spectrum using one of the following equations (3) and (4).

$$\begin{matrix}S ( {f}_{x} , {f}_{y} ) = \frac{F ( {f}_{x} , {f}_{y} )}{\vert F ( {f}_{x} , {f}_{y} ) \vert} \frac{G * ( {f}_{x} , {f}_{y} )}{\vert G ( {f}_{x} , {f}_{y} ) \vert} & ( 3 ) \\ S ( {f}_{x} , {f}_{y} ) = \frac{F ( {f}_{x} , {f}_{y} ) G * ( {f}_{x} , {f}_{y} )}{\vert F ( {f}_{x} , {f}_{y} ) G * ( {f}_{x} , {f}_{y} ) \vert} & ( 4 )\end{matrix}$$

In the above-described equations, fₓ and f_{y} denote frequency space, and the symbol * included in G*(fₓ, f_{y}) denotes a complex conjugate of G(fₓ, f_{y}).

In step S8, the inverse Fourier transform unit 52 performs a two-dimensional fast inverse Fourier transform upon the cross power spectrum output from the cross power spectrum detection unit 51. More specifically, the inverse Fourier transform unit 52 computes the value s(x, y) represented in the following equation (5).

$$s ( x , y ) = {\int }_{- ∞}^{+ ∞} {\int }_{- ∞}^{+ ∞} S ( {f}_{x} , {f}_{y} ) {e}^{2 π j ( {f}_{x} x + {f}_{y} y )} d {f}_{x} d {f}_{y} \qquad ( 5 )$$

In step S9, the normalization section 16 normalizes the output s(x, y) of the inverse Fourier transform unit 52 so that the maximum value thereof can be one. More specifically, the following equation (6) is computed. The value represented in the denominator on the right-hand side in equation (6) denotes the maximum value of the absolute value of the value s(x, y).

$$p ( x , y ) = \frac{\vert s ( x , y ) \vert}{max ( \vert s ( x , y ) \vert )} \qquad ( 6 )$$

In step S10, the counter section 17 counts the number of amplitudes having a value equal to or larger than a threshold value. In step S11, the determination section 18 determined whether the value counted in step S10 is equal to or larger than a threshold value that has been set in advance. If the counted value is equal to or larger than the threshold value, the determination section 18 determines that one of the images being processed is a scene change in step S12. On the other hand, if it is determined that the counted value is not equal to or larger than the threshold value, the determination section 18 determines that one of the images being processed is not a scene change in step S14.

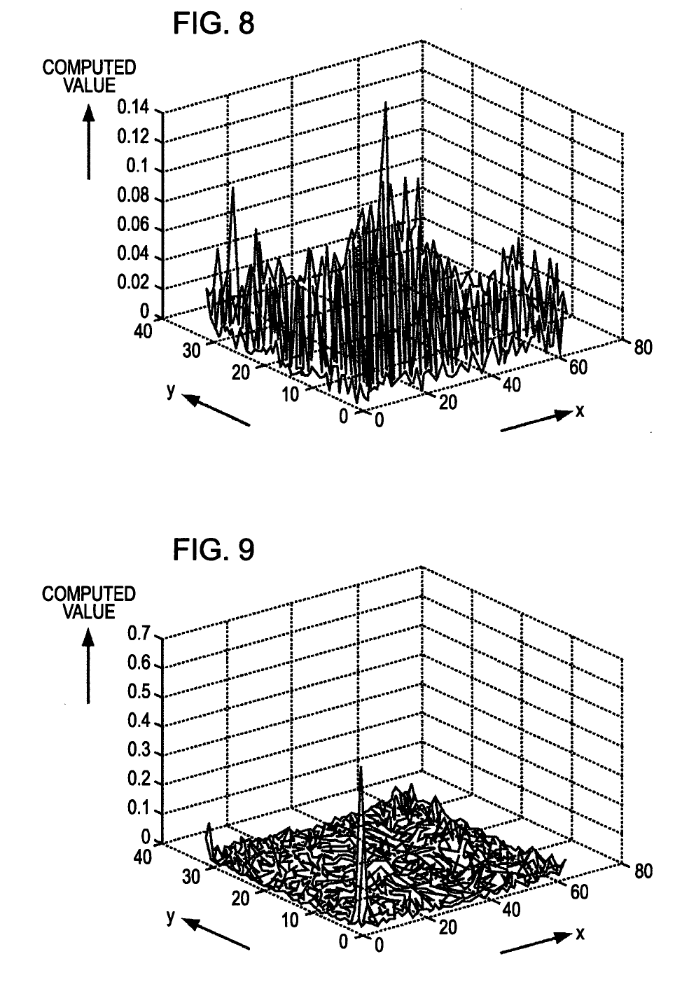

That is, if the correlation level is low, the output of the inverse Fourier transform unit 52 which has been normalized by the normalization section 16 is represented as shown in FIG. 8. On the other hand, if the correlation level is high, the output of the inverse Fourier transform unit 52 is represented as shown in FIG. 9. In FIGS. 8 and 9, computed values corresponding to the x and y coordinates representing positions on an image are shown. If one of the images being processed is a scene change, the level of the correlation between the two frames is low. Accordingly, as shown in FIG. 8, a number of values of amplitudes in individual coordinates are larger than a reference value that has been set in advance. On the other hand, if one of the images being processed is not a scene change, the level of the correlation between the two frames is high. Accordingly, as shown in FIG. 9, a small number of values of amplitudes in individual coordinates are larger than a reference value that has been set in advance. Hence the determination processing operations of steps S11, S12, and S14 are performed.

If it is determined in step S12 that one of the images being processed is a scene change, the storage section 19 stores the determination result in step S13. That is, the fact that one of the frames being processed (here, the frame whose image signal has been received by the image input section 11A) is a scene change is stored along with the image signal received by the image input section 11A in the storage section 19.

After the processing operations of steps S13 and 14 have been performed, the determination section 18 determines whether all frames have already been subjected to detection processing in step S15. If all frames have not yet been subjected to detection processing, the process returns to step S1 and the process from step S1 to the subsequent steps is repeatedly performed. If it is determined that all frames have already been subjected to detection processing, the scene change detection ends.

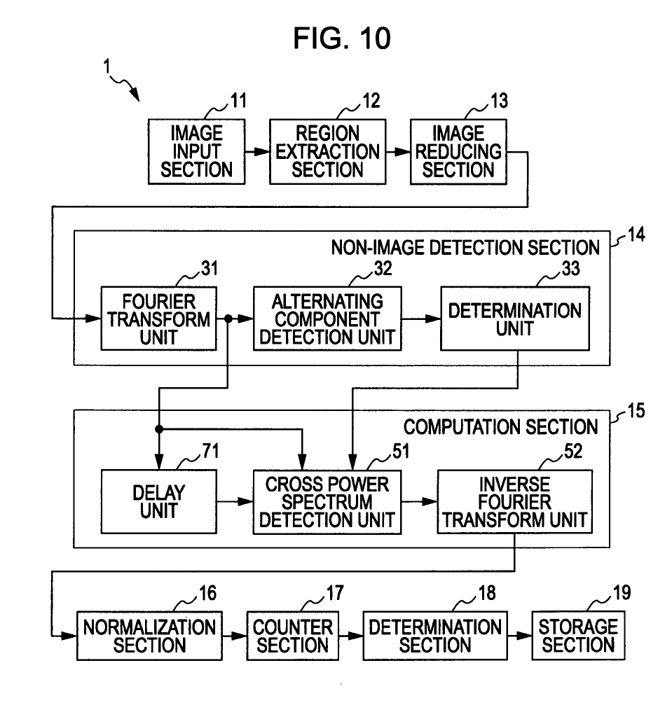

In the image processing apparatus shown in FIG. 1, dedicated processing sections for processing images forming different frames (two-channel processing section) are disposed. However, some of these sections may be integrated. FIG. 10 shows a configuration of an image processing apparatus used in such a case.

That is, the image processing apparatus 1 shown in FIG. 10 is provided with an image input section 11, a region extraction section 12, an image reducing section 13, and a non-image detection section 14, each of which is a one-channel section. In the computation section 15, a delay unit 71 is disposed in addition to the cross power spectrum detection unit 51 and the inverse Fourier transform unit 52. The output of a Fourier transform unit 31, which configures the non-image detection section 14 with an alternating component detection unit 32 and a determination unit 33, is supplied to not only the alternating component detection unit 32 but also the cross power spectrum detection unit 51 and the delay unit 71 in the computation section 15. The delay unit 71 delays the output of the Fourier transform unit 31 by a time corresponding to the predetermined number of frames and transmits the delayed output to the cross power spectrum detection unit 51. Other sections are the same as those shown in FIG. 1.

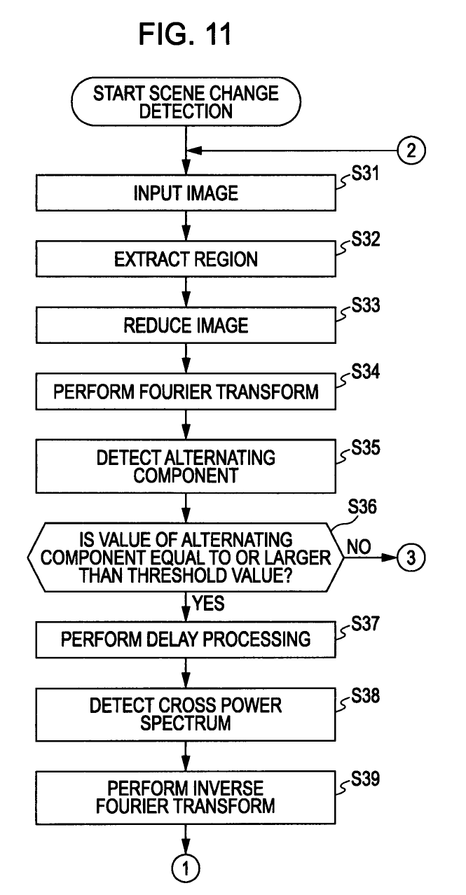

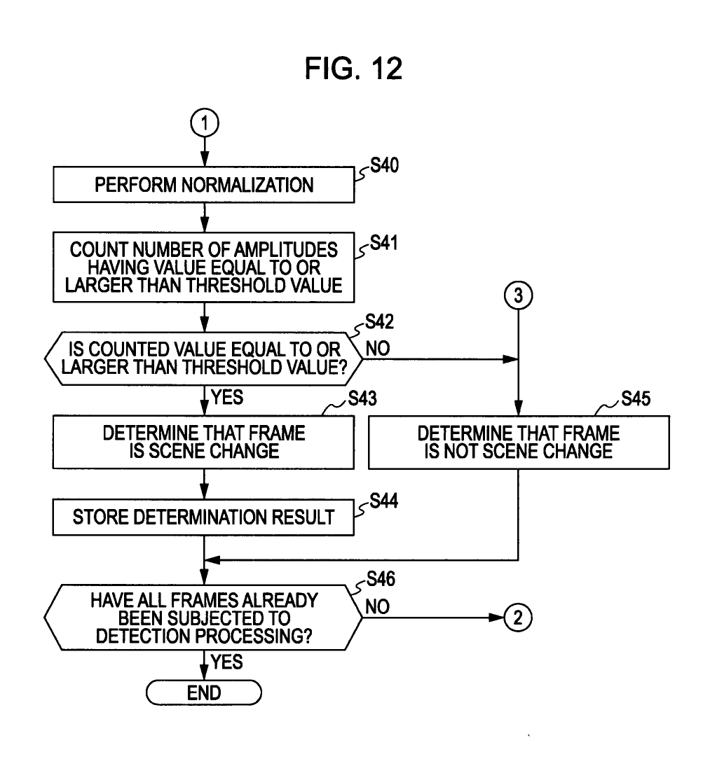

FIGS. 11 and 12 show scene change detection performed by the image processing apparatus shown in FIG. 10. The process from step S31 to step S46 is the same as the process from step S1 to step S15 shown in FIGS. 2 and 3 except for the following difference. The different is that step S37 is added between step S36 corresponding to step S6 shown in FIG. 2 and step 38 corresponding to step S7 shown in FIG. 2.

That is, in the scene change detection performed by the image processing apparatus shown in FIG. 10, if it is determined in step S36 that the value of an alternating component is equal to or larger than the threshold value, the delay unit 71 delays the output of the Fourier transform unit 31 by a time corresponding to the predetermined number of frames in step S37. The delayed signal is supplied to the cross power spectrum detection unit 51. In step S38, the cross power spectrum detection unit 51 detects a cross power spectrum using image signals forming different frames, one of which has been transmitted directly from the Fourier transform unit 31 and the other one of which has been transmitted from the Fourier transform unit 31 via the delay unit 71. Other processing operations are the same as those performed in the image processing apparatus shown in FIG. 1.

The configuration of the image processing apparatus shown in FIG. 10 is simplified compared with that of the image processing apparatus shown in FIG. 1.

FIG. 13 shows a configuration of the image processing apparatus 1 according to another embodiment of the present invention. In this image processing apparatus, a simplified detection section 81 is disposed between the image reducing sections 13A and 13B and the non-image detection sections 14A and 14B. The simplified detection section 81 is provided with the difference computation unit 91 and a determination unit 92. The difference computation unit 91 computes the difference between the outputs of the image reducing sections 13A and 13B, and outputs the computation result to the determination unit 92. The determination unit 92 performs determination processing on the basis of the difference computation result obtained from the difference computation unit 91, and controls the operations of the Fourier transform units 31A and 31B on the basis of the determination result. Other sections and units are the same as those included in the image processing apparatus shown in FIG. 1.

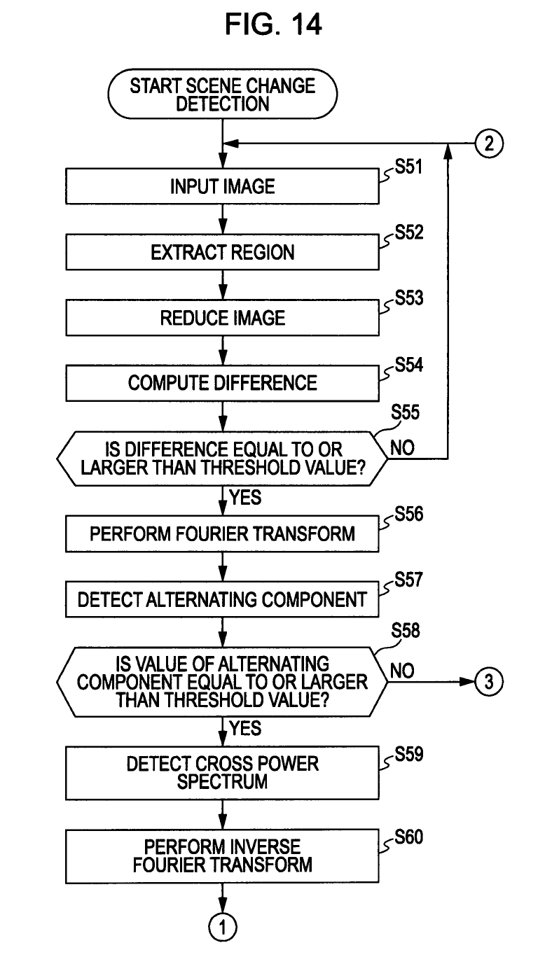

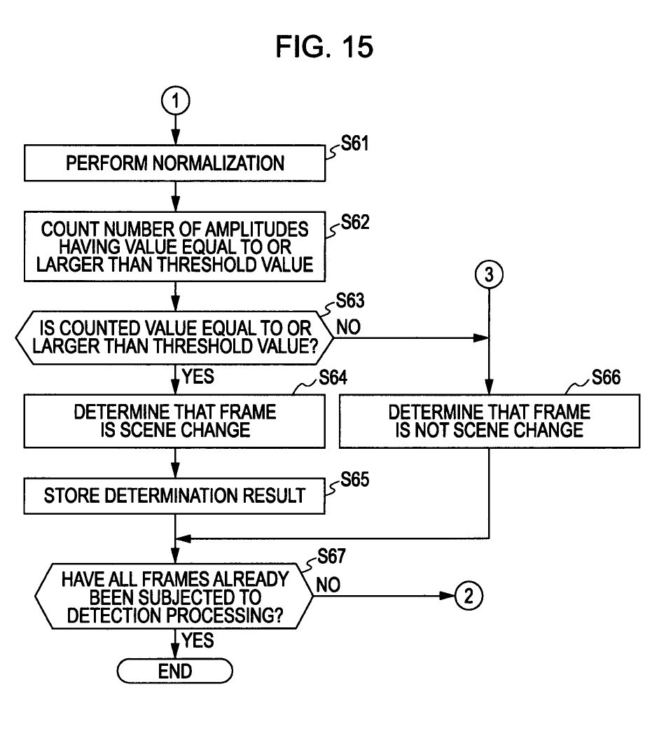

Next, scene change detection performed by the image processing apparatus 1 shown in FIG. 13 will be described with reference to flowcharts shown in FIGS. 14 and 15.

In step S51, the image input sections 11A and 11B receive images forming different frames. In step S52, the region extraction sections 12A and 12B extract image signals corresponding to predetermined regions of the images represented by image signals transmitted from the image input sections 11A and 11B, respectively. In step S53, the image reducing sections 13A and 13B reduce the sizes of the regions represented by the image signals extracted by the region extraction sections 12A and 12B, respectively. This process from step S51 to S53 is the same as the process from step S1 to S3 shown in FIG. 2.

Next, in step S54, the difference computation unit 91 computes the difference between the outputs of the image reducing sections 13A and 13B. In step S55, the determination unit 92 compares the difference computed in step S54 with a predetermined threshold value that has been set in advance so as to determine whether the difference value is equal to or larger than the threshold value. If the difference value is not equal to or larger than the threshold value, the process returns to step S51 and the process from step S51 to the subsequent steps is repeatedly performed. On the other hand, if the difference value is equal to or larger than the threshold value, the process proceeds to step S56. The process from step S56 to step S67 is the same as the process from step S4 shown in FIG. 2 to step S15 shown in FIG. 3.

That is, in this image processing apparatus according to another embodiment of the present invention, if it is determined in step S55 that the difference value is not equal to or larger than the threshold value, the process from step S56 to the subsequent steps is interrupted. Only if the difference value is equal to or larger than the threshold value, is the process from step S56 to the subsequent steps performed. If one of the images being processed is a scene change, the difference between the images forming two different frames often becomes equal to or larger than the threshold value. On the other hand, if one of the images being processed is not a scene change, the difference becomes comparatively small. Accordingly, by comparing a difference between images forming two different frames, whether one of the images being processed is a scene change can be easily detected. If it is determined by the simplified detection that one of the images being processed is not a scene change, the subsequent detailed scene change detection is interrupted. Accordingly, performance of unnecessary processing can be avoided.

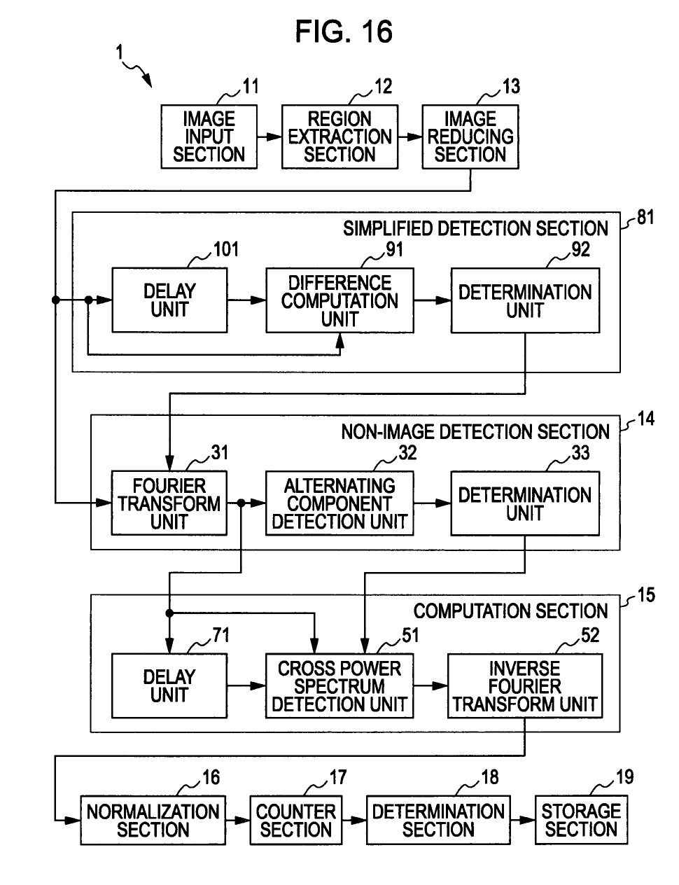

In the image processing apparatus shown in FIG. 13, processing sections for processing images forming different frames may also be integrated. FIG. 16 shows a configuration of an image processing apparatus used in such a case.

That is, the image processing apparatus shown in FIG. 16 has a configuration in which the simplified detection section 81 is added between the image reducing section 13 and the non-image detection section 14 in the image processing apparatus shown in FIG. 10. In addition, a delay unit 101 is disposed in the simplified detection section 81 in addition to the difference computation unit 91 and the determination unit 92. The delay unit 101 delays the output of the image reducing section 13 by a time corresponding to the predetermined number of frames, and transmits the delayed output to the difference computation unit 91. The difference computation unit 91 computes the difference between image signals, one of which has been transmitted from the image reducing section 13 via the delay unit 101 and the other one of which has been transmitted directly from the image reducing section 13, and outputs the computation result to the determination unit 92.

That is, in the image processing apparatus show in FIG. 16, since the delay unit 101 delays the output of the image reducing section 13 by a time corresponding to the predetermined number of frames and transmits the delayed output to the difference computation unit 91, image signals of images forming different frames can be supplied to the difference computation unit 91 so as to cause the difference computation unit 91 to compute the difference between the image signals. Consequently, the configuration of the image processing apparatus can be simplified, and performance of unnecessary processing can be avoided.

In the above-described embodiments, image forming frames are processed. However, a frame may be divided into a plurality of regions and the divided regions may be processed. FIG. 17 shows a configuration of an image processing apparatus used in such a case. That is, in this image processing apparatus according to another embodiment of the present invention, an image that has been processed by the image input section 11, the region extraction section 12, and the image reducing section 13 is supplied to the dividing section 111 and is then divided into two different regions.

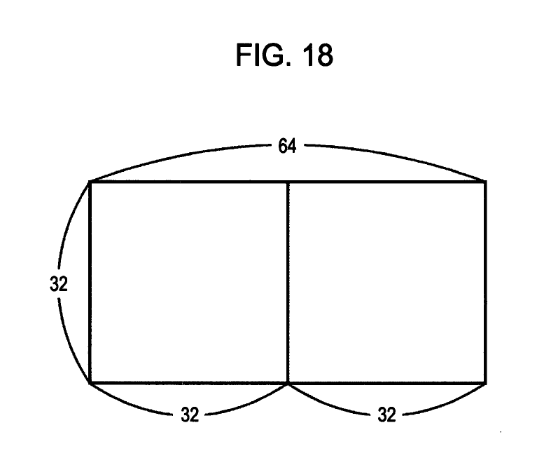

More specifically, as shown in FIG. 18, the dividing section 111 divides an image of 64×32 pixels, which the image reducing section 13 has created by reducing the size of an original image, into two regions of 32×32 pixels. In order to process an image signal corresponding to one of the regions (for example, a region on the left side in FIG. 18), the non-image detection section 14A, a computation section 15A, a normalization section 16A, a counter section 17A, and a determination section 18A are disposed. In order to process an image signal corresponding to the other one of the regions (for example, a region on the right side in FIG. 18), the non-image detection section 14B, a computation section 15B, a normalization section 16B, a counter section 17B, and a determination section 18B are disposed.

That is, the configuration of the part of the image processing apparatus shown in FIG. 17 which is used to process a signal corresponding to each region is the same as the configuration shown in FIG. 10.

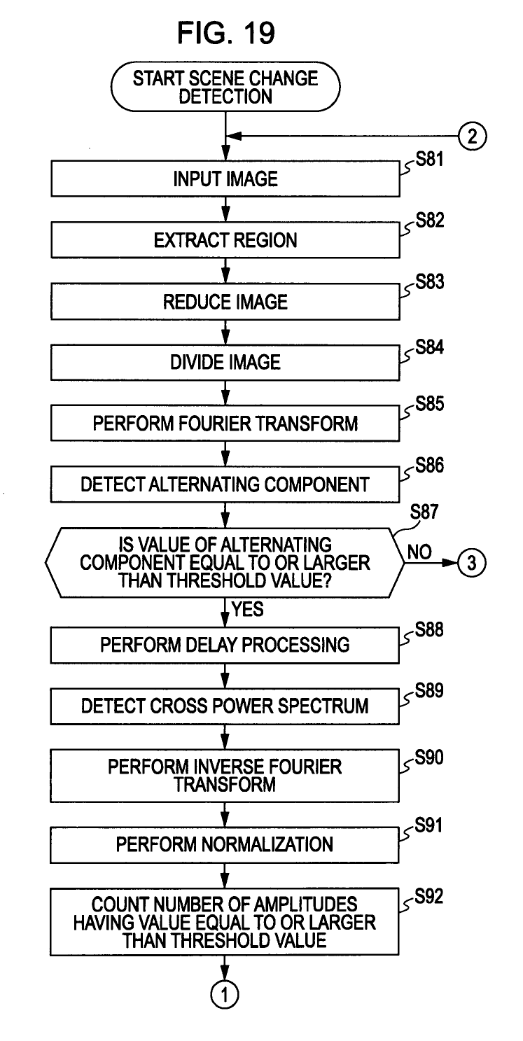

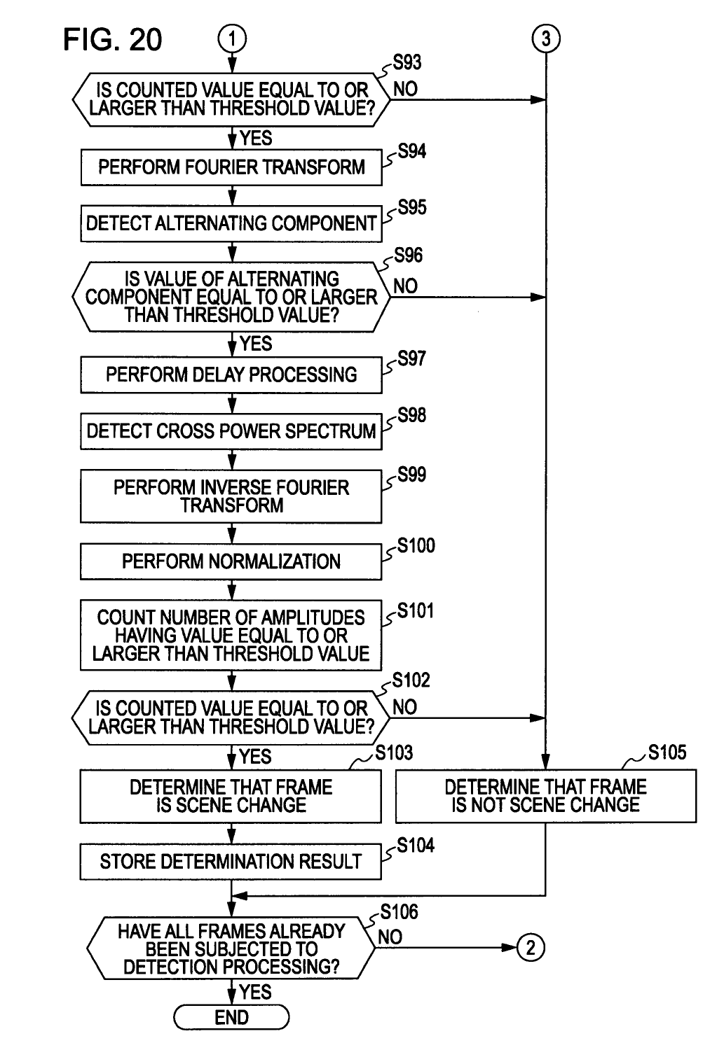

Next, scene change detection preformed by the image processing apparatus shown in FIG. 17 will be described with reference to flowcharts shown in FIGS. 19 and 20.

In step S81, the image input section 11 receives an image. In step S82, the region extraction section 12 extracts an image signal corresponding to a predetermined region of the image represented by an image signal transmitted from the image input section 11. In step S83, the image reducing section 13 reduces the size of the region represented by the image signal extracted by the region extraction section 12. This process from step S81 to step S83 is the same as the process from step S1 to step S3 in FIG. 2.

Next, in step S84, as shown in FIG. 18, the dividing section 111 divides the image of 64×32 pixels, which is represented by the image signal transmitted from the image reducing section 13, into two images of 32×32 pixels, and supplies an image signal corresponding to one of the images to the non-image detection section 14A and an image signal corresponding to the other one of the images to the non-image detection sections 14B.

In the subsequent process, the same processing as the above-described processing is performed upon each of the divided images. That is, in step S85, the Fourier transform unit 31A in the non-image detection section 14A performs a two-dimensional fast Fourier transform upon the image signal corresponding to the image of 32×32 pixels which has been transmitted from the dividing section 111. In step S86, the alternating component detection unit 32A detects an alternating component from the image signal transmitted from the Fourier transform unit 31A. In step S87, the determination unit 33A determines whether the value of the alternating component transmitted from the alternating component detection unit 32A is equal to or larger than a threshold value. If the value of the alternating component is not equal to or larger than the threshold value, the determination unit 33A interrupts the operation of a cross power spectrum detection unit 51A. In this case, the process proceeds to step S105 in which the determination unit 33A determines that the image being processed is not a scene change. Subsequently, in step S106, the determination unit 33A determines whether all frames have already been subjected to detection processing. If all frames have not yet been subjected to detection processing, the process returns to step S81 and the process from step S81 to the subsequent steps is repeatedly performed.

If it is determined in step S87 that the value of the alternating component is equal to or larger than the threshold value, a delay unit 121A delays the signal transmitted from the Fourier transform unit 31A by a time corresponding to the predetermined number of frames in step S88. The delayed signal is supplied to the cross power spectrum detection unit 51A. In step S89, the cross power spectrum detection unit 51A detects a cross power spectrum using signals forming different frames, one of which has been transmitted directly from the Fourier transform unit 31A and the other one of which has been transmitted from the Fourier transform unit 31A via the delay unit 121A. In step S90, an inverse Fourier transform unit 52A performs a two-dimensional fast inverse Fourier transform upon the output of the cross power spectrum detection unit 51A.

In step S91, the normalization section 16A normalizes the output of the inverse Fourier transform unit 52A. In step S92, the counter section 17A counts the number of amplitude having a value equal to or larger than a threshold value. In step S93, the determination section 18A determines whether the value counted in step S92 is equal to or larger than a threshold value that has been set in advance. If the counted value is not equal to or larger than the threshold value, the process proceeds to step S105 in which the determination section 18A determines that the image being processed is not a scene change. Subsequently, in step S106, the determination section 18A determines whether all frames have already been subjected to detection processing. If all frames have not yet been subjected to detection processing, the process returns to step S81 and the process from step S81 to the subsequent steps is repeatedly performed.

If it is determined in step S93 that the counted value is equal to or larger than the threshold value, the same processing operations as those of step S85 to step S93 are performed upon the image signal corresponding to the other one of the divided images of 32×32 pixels in step S94 to step S102 by the Fourier transform unit 31B, the alternating component detection unit 32B, the determination unit 33B, a delay unit 121B, a cross power spectrum detection unit 51B, an inverse Fourier transform unit 52B, the normalization section 16B, the counter section 17B, and the determination section 18B.

In reality, the process from step S94 to step S102 is performed in parallel with the process from step S85 to step S93.

If it is determined in step S102 that the counted value is equal to or larger than the threshold value, that is, if it is determined that the numbers of amplitudes having a value equal to or larger than the threshold value in the regions of 32×32 pixels on the left and right sides in FIG. 18 are equal to or larger than the threshold value and the states of the regions are as shown in FIG. 8, the determination section 18B determines that the frame being processed is a scene change in step S103. Subsequently, in step S104, the storage section 19 stores the result of the determination performed in step S103.

After the processing of step S104 or step S105 has been performed, the determination section 18B determines whether all frames have already been subjected to detection processing in step S106. If all frames have not yet been subjected to detection processing, the process returns to step S81 and the process from step S81 to the subsequent steps is repeatedly performed. If it is determined that all frames have already been subjected to detection processing, the scene change detection ends.

Next, a method of detecting a representative image of a scene will be described. FIG. 21 shows a configuration of an image processing apparatus according to another embodiment of the present invention which is used in such a case. In this image processing apparatus, the representative image detection section 201 is disposed in addition to the image input section 11 through the storage section 19 shown in FIG. 10. The representative image detection section 201 is provided with a vector detection unit 211 and a determination unit 212.

The vector detection unit 211 detects a motion vector from the output of the inverse Fourier transform unit 52. The determination unit 212 included in the representative image detection section 201 detects a frame number corresponding to the minimum motion vector among motion vectors that have been detected by the vector detection unit 211.

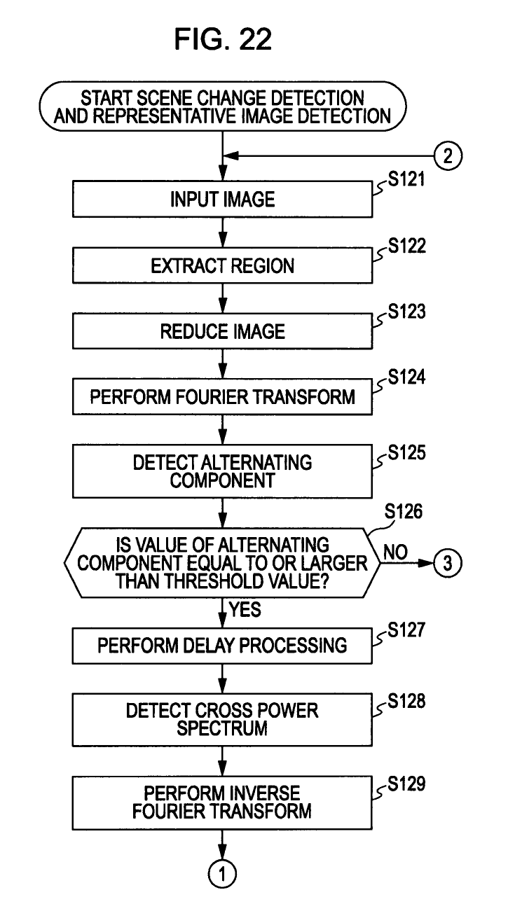

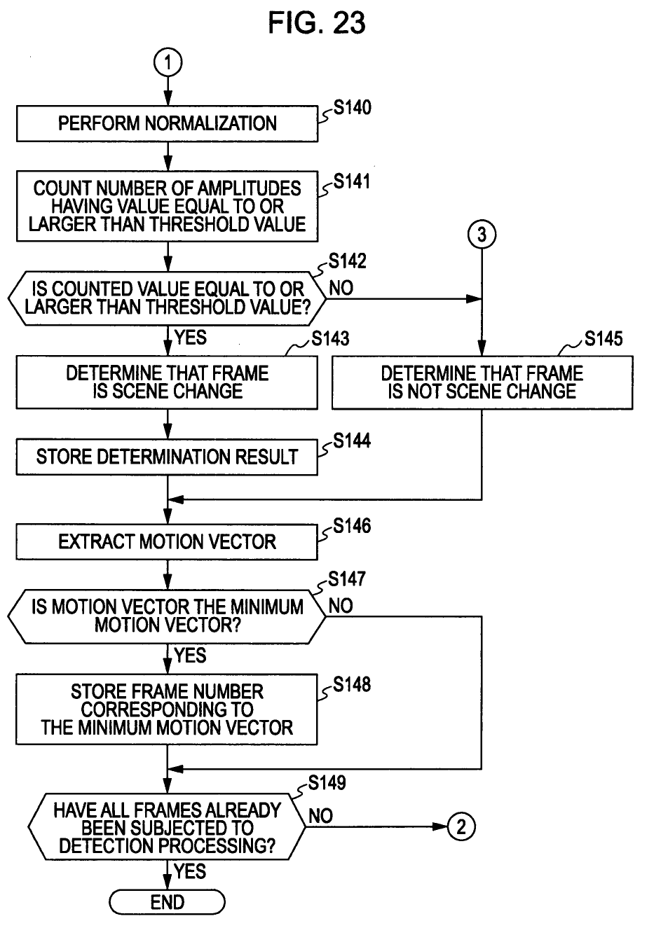

Next, scene change detection and representative image detection performed by the image processing apparatus shown in FIG. 21 will be described with reference to flowcharts shown in FIGS. 22 and 23.

The process from step S121 to step S145 is the same as the process from the step S31 shown in FIG. 11 to step S45 shown in FIG. 12. That is, as described previously, whether a frame being processed is a scene change is determined by this process. Subsequently, in step S146, the vector detection unit 211 detects a motion vector from the output of the inverse Fourier transform unit 52. More specifically, as shown in FIG. 9, the maximum amplitude is detected among the results of computation compliant with SPOMF which have been performed for individual coordinate positions, and the coordinate position corresponding to the maximum amplitude (more precisely, a distance from the origin to the coordinates) is detected as a motion vector. In step S147, the determination unit 212 determines whether the motion vector detected in step S146 is the minimum motion vector. This determination is performed by determining whether the detected motion vector is smaller than motion vectors that have already been detected and stored. If the detected motion vector is the minimum motion vector, that is, the detected motion vector is smaller than the motion vectors that have already been stored, the storage section 19 stores in step S148 a frame number corresponding to the minimum motion vector detected in step S146. If it is determined in step S147 that the detected motion vector is not the minimum motion vector, the processing of step S148 is skipped.

In step S149, the determination unit 212 determines whether all frames have already been subjected to detection processing. If all frames have not yet been subjected to detection processing, the process returns to step S121 and the process from step S121 to the subsequent steps is repeatedly performed. If it is determined that all frames have already been subjected to detection processing, the scene change detection and the representative image detection end.

Thus, a most motionless frame (a frame in which the coordinates corresponding to the maximum amplitude thereof is closest to the origin (0, 0) as shown in FIG. 9) is stored as a representative image of each scene. For example, in a case where a frame obtained after a predetermined time has passed from the occurrence of a scene change is set as a representative image, if a shutter speed becomes relatively low due to camera-shake, a blurred image or an out-of-focus image is sometimes set as a representative image. However, according to the above-described image processing apparatus, such problems can be prevented.

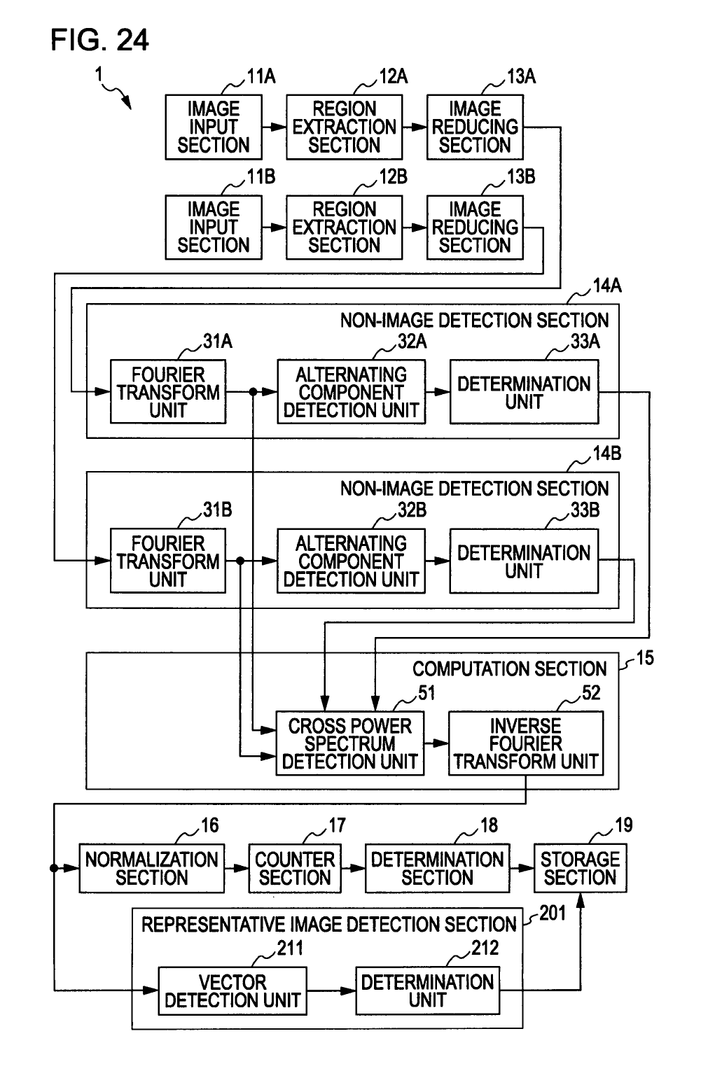

FIG. 24 shows a configuration of an image processing apparatus according to another embodiment of the present invention which is used to detect a representative image. In this image processing apparatus, the representative image detection section 201 including the vector detection unit 211 and the determination unit 212 is disposed in addition to the sections and units included in the image processing apparatus shown in FIG. 1. In scene change detection and representative image detection performed by this image processing apparatus, the process from step S1 shown in FIG. 2 to step S15 shown in FIG. 3 is performed and then the process from step S146 to S149 shown in FIG. 23 is performed.

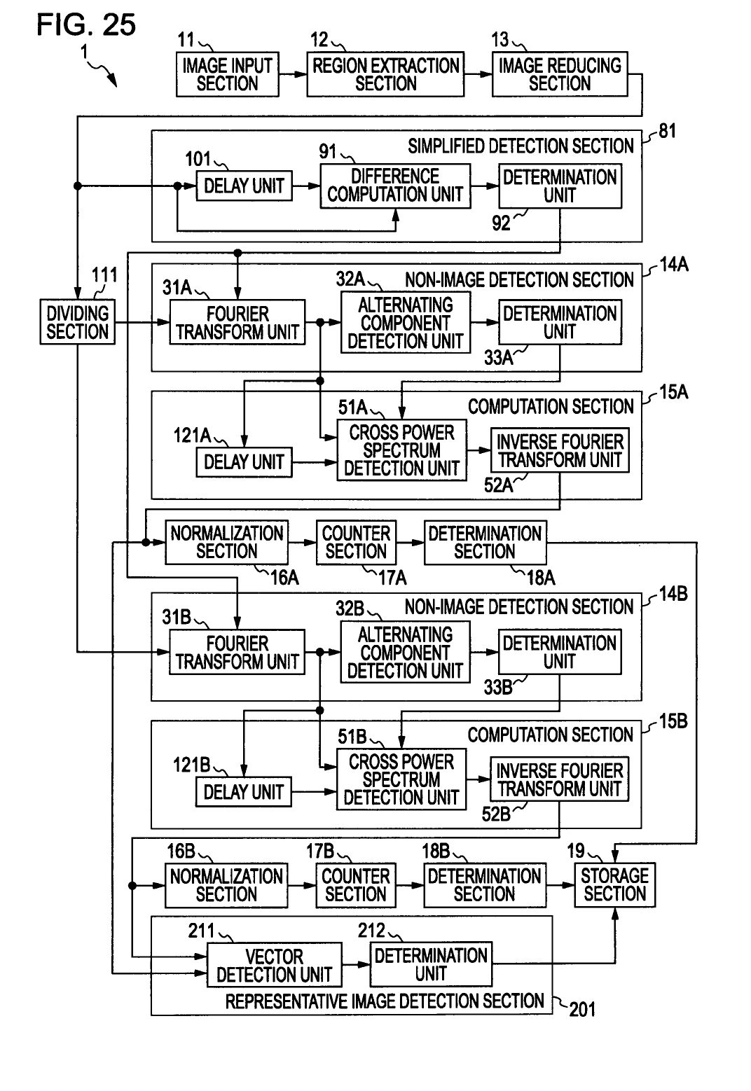

FIG. 25 shows a configuration of an image processing apparatus according to another embodiment of the present invention in which the simplified detection section 81 shown in FIG. 16 and the representative image detection section 201 shown in FIG. 21 are disposed in addition to the sections and units included in the image processing apparatus shown in FIG. 17. In this image processing apparatus, a signal output from the image reducing section 13 is supplied to the delay unit 101 included in the simplified detection section 81. The operation of the Fourier transform unit 31A in the non-image detection section 14A and the operation of the Fourier transform unit 31B in the non-image detection sections 14B are controlled on the basis of the output of the determination unit 92. Signals output from the inverse Fourier transform units 52A and 52B are supplied to the vector detection unit 211 included in the representative image detection section 201. Other configurations are the same as those shown in FIG. 17.

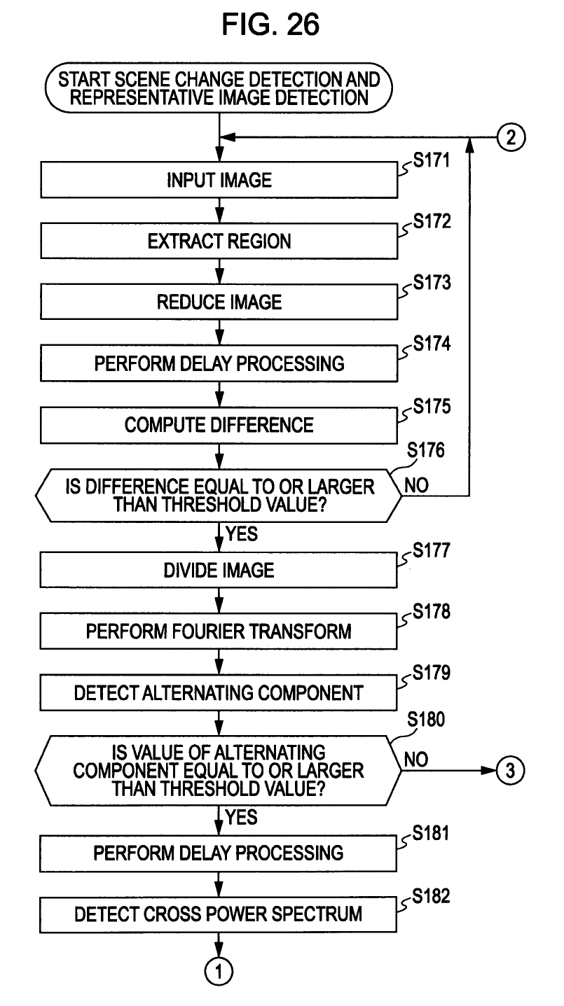

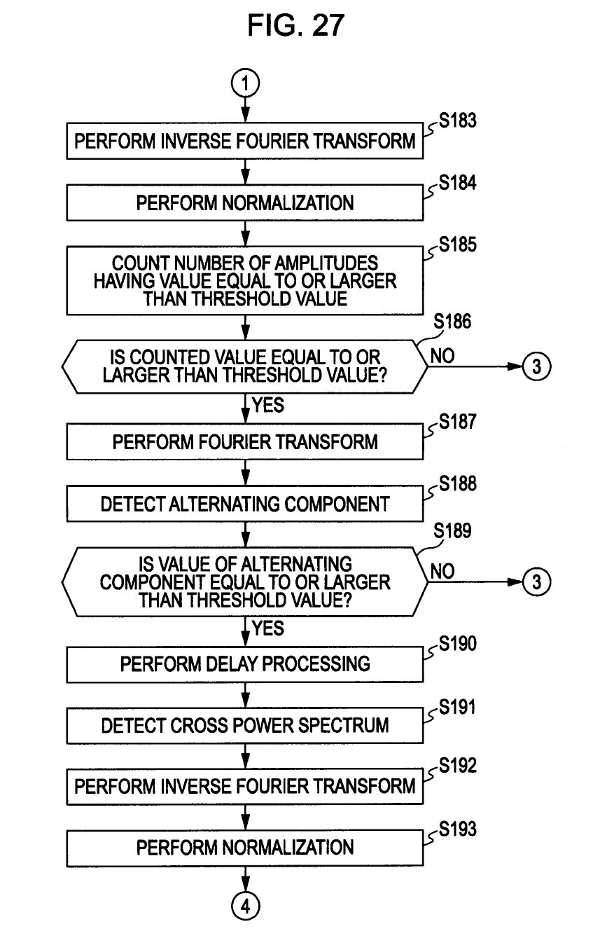

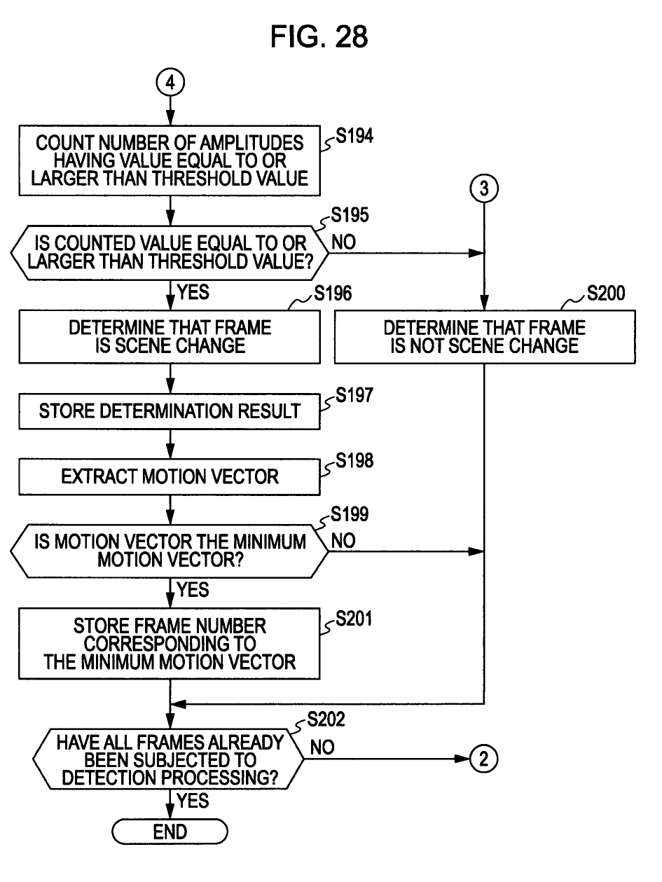

Next, scene change detection and representative image detection performed by the image processing apparatus shown in FIG. 25 will be described with reference to flowcharts shown in FIGS. 26 to 28.

In step S171, the image input section 11 receives an image. In step S172, the region extraction section 12 extracts an image signal corresponding to a predetermined region of the image represented by an image signal transmitted from the image input section 11. In step S173, the image reducing section 13 reduces the size of the region represented by the image signal extracted by the region extraction section 12. In step S174, the delay unit 101 delays the signal transmitted from the image reducing section 13 and outputs the delayed signal to the difference computation unit 91. In step S175, the difference computation unit 91 computes the difference between signals of images forming different frames, one of which has been transmitted directly from the image reducing section 13 and the other one of which has been transmitted from the image reducing section 13 via the delay unit 101. In step S176, the determination unit 92 determines whether the difference value computed in step S175 is equal to or larger than a threshold value that has been set in advance. If the difference value is not equal to or larger than the threshold value, the process returns to step S171 and the process from step S171 to the subsequent steps is repeatedly performed.

If it is determined in step S176 that the difference value is equal to or larger than the threshold value, the dividing section 111 divides an image represented by a signal transmitted from the image reducing section 13 in step S177. In the following process from step S178 to S186, each of the non-image detection section 14A, the computation section 15A, the normalization section 16A, the counter section 17A, and the determination section 18A performs processing upon an image signal corresponding to one of the divided images. In the process from step S187 to step S195, each of the non-image detection sections 14B, the computation section 15B, the normalization section 16B, the counter section 17B, and the determination section 18B performs processing upon an image signal corresponding to the other one of the divided images. These processes correspond to the process from step S85 shown in FIG. 19 to step S102 shown in FIG. 20.

If it is determined in step S195 that the counted value is not equal to or larger than the threshold value, it is determined in step S180 that the value of the alternating component is not equal to or larger than the threshold value, it is determined in steps S186 that the counted value is not equal to or larger than the threshold value, or it is determined in step S189 that the value of the alternating component is not equal to or larger than the threshold value, the determination section 18B determines that the frame being processed is not a scene change in step S200. Subsequently, the determination section 18B determines whether all frames have already been subjected to detection processing in step S202. If all frames have not yet been subjected to detection processing, the process returns to step S171 and the process from step S171 to the subsequent steps is repeatedly performed.

If it is determined in step S195 that the counted value is equal to or larger than the threshold value, the determination section 18B determines that the frame being processed is a scene change in step S196. In step S197, the storage section 19 stores the result of the determination performed in step S196.

Thus, after the scene change detection has been performed, the vector detection unit 211 extracts a motion vector in step S198. More specifically, the vector detection unit 211 determines which of the outputs of the inverse Fourier transform units 52A and 52B is closer to the origin (which of the motion vectors is smaller), and extracts the determination result as a motion vector. In step S199, the determination unit 212 determines whether the motion vector extracted in step S198 is the minimum motion vector.

If the extracted motion vector is the minimum motion vector, the storage section 19 stores a frame number corresponding to the minimum motion vector in step S201. If the extracted motion vector is not the minimum motion vector, the processing of step S201 is skipped. Subsequently, the determination section 18B determines whether all frames have already been subjected to detection processing. If all frames have not yet been subjected to detection processing, the process returns to step S171 and the process from step S171 to the subsequent steps is repeatedly performed. If it is determined that all frames have already been subjected to detection processing, the scene change detection and the representative image detection end.

Thus, not only an image signal of the image received by the image input section 11 but also a scene change and a representative image (most motionless image) of each scene are stored in the storage section 19.

By reducing the sizes of images, the adverse effect of image rotation on the scene change detection can be prevented. However, the adverse effect can be further prevented by using a configuration shown in FIG. 29.

That is, in an image processing apparatus shown in FIG. 29, the non-image detection section 14A detects a non-image on the basis of the results of processing operations performed by the image input section 11A, the region extraction section 12A, and the image reducing section 13A. The non-image detection section 14B detects a non-image on the basis of the results of processing operations performed by the image input section 11B, the region extraction section 12B, and the image reducing section 13B. The output of the Fourier transform unit 31A (also functioning as a Fourier transform unit in the computation section 15) included in the non-image detection section 14A is directly supplied to one of input terminals of the cross power spectrum detection unit 51 in the computation section 15.

On the other hand, the output of the Fourier transform unit 31B included in the non-image detection sections 14B is supplied to the rotation/scaling transformation section 304. The rotation/scaling transformation section 304 performs rotation or scaling transformation upon the image signal transmitted from the Fourier transform unit 31B in accordance with a control signal transmitted from a rotation/scaling detection section 303, and outputs the processed signal to a Fourier transform unit 341 in the computation section 15. The Fourier transform unit 341 performs a Fourier transform upon the signal transmitted from the rotation/scaling transformation section 304, and supplies the processed signal to the other one of the input terminals of the cross power spectrum detection unit 51.

The output of the Fourier transform unit 31A included in the non-image detection section 14A is also supplied to the amplitude spectrum computation unit 311A included in a computation section 301A. The amplitude spectrum computation unit 311A computes an amplitude spectrum of the signal transmitted from the Fourier transform unit 31A. The log-polar coordinate transformation unit 312A in the computation section 301A transforms the computation result into log-polar coordinates and supplies the processed signal to a Fourier transform unit 331A included in a computation section 302. The operation of the amplitude spectrum computation unit 311A is controlled in accordance with the output of the determination unit 33A included in the non-image detection section 14A.

Similarly, the amplitude spectrum computation unit 311B included in a computation section 301B computes an amplitude spectrum of the output of the Fourier transform unit 31B included in the non-image detection sections 14B, and outputs the computation result to the log-polar coordinate transformation unit 312B included in the computation section 301B. The log-polar coordinate transformation unit 312B transforms the signal transmitted from the amplitude spectrum computation unit 311B into log-polar coordinates, and outputs the processed signal to a Fourier transform unit 331B included in the computation section 302. The operation of the Fourier transform unit 331B is controlled in accordance with the output of the determination unit 33B included in the non-image detection sections 14B.

A cross power spectrum detection unit 332 included in the computation section 302 that performs computation compliant with SPOMF detects a cross power spectrum using outputs of the Fourier transform units 331A and 331B. An inverse Fourier transform unit 333 performs a fast inverse Fourier transform upon the cross power spectrum output from the cross power spectrum detection unit 332. The rotation/scaling detection section 303 detects rotation or scaling of the image from the output of the inverse Fourier transform unit 333, and controls the rotation/scaling transformation section 304 on the basis of the detection result.

Like the case of the image processing apparatus shown in FIG. 1, the output of the computation section 15 is processed by the normalization section 16, the counter section 17, determination section 18, and the storage section 19.

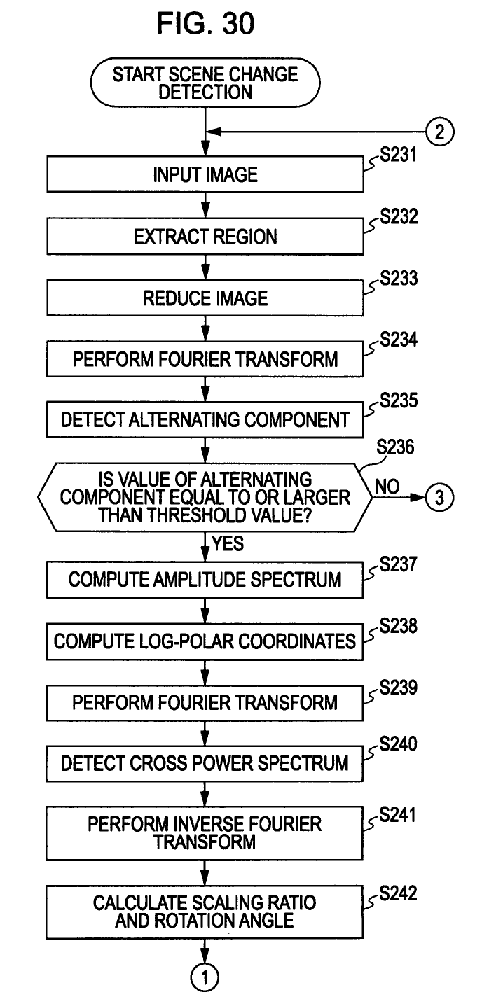

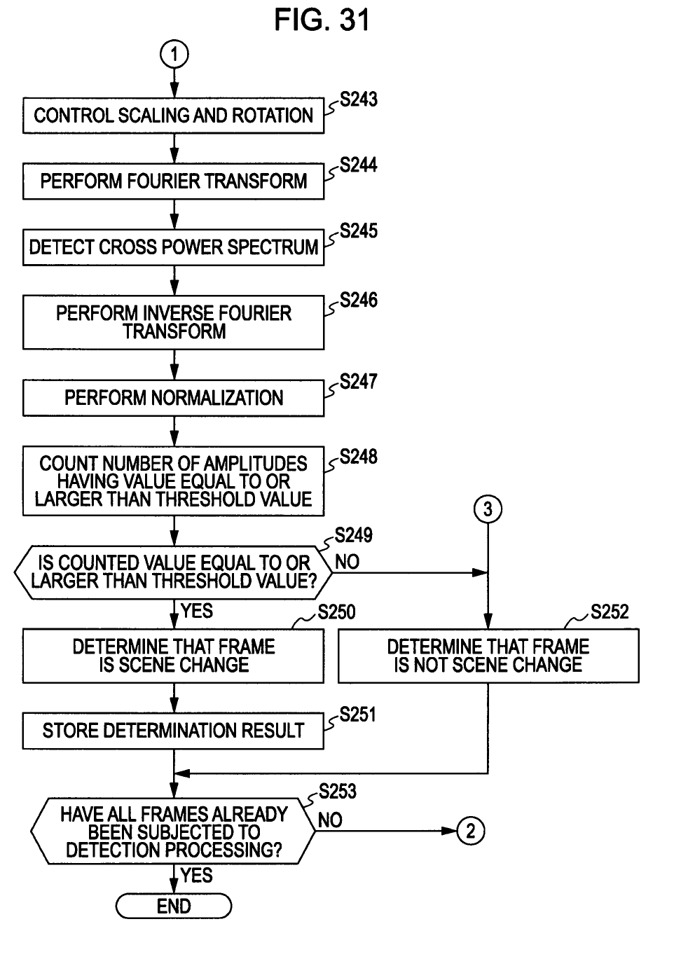

Next, scene change detection perform by the image processing apparatus shown in FIG. 29 will be described with reference to flowcharts shown in FIGS. 30 and 31. In step S231, the image input sections 11A and 11B receive images forming different frames. In step S232, the region extraction sections 12A and 12B extract image signals corresponding to predetermined regions of the images represented by image signals output from the image input sections 11A and 11B respectively. In step S233, the image reducing sections 13A and 13B reduce the sizes of the regions represented by the image signals output from the region extraction sections 12A and 12B, respectively.

In step 234, the Fourier transform units 31A and 31B perform two-dimensional fast Fourier transforms upon the signals output from the image reducing sections 13A and 13B, respectively. More specifically, the following equations (7) and (8) are computed.

$$\begin{matrix}\begin{matrix}F ( {f}_{x} , {f}_{y} ) = {\int }_{- ∞}^{+ ∞} {\int }_{- ∞}^{+ ∞} f ( x , y ) {e}^{- 2 π j ( {f}_{x} x + {f}_{y} y )} d x d y \\ = {A}_{F} ( {f}_{x} , {f}_{y} ) + {jB}_{F} ( {f}_{x} , {f}_{y} )\end{matrix} & ( 7 ) \\ \begin{matrix}G ( {f}_{x} , {f}_{y} ) = {\int }_{- ∞}^{+ ∞} {\int }_{- ∞}^{+ ∞} g ( x , y ) {e}^{- 2 π j ( {f}_{x} x + {f}_{y} y )} d x d y \\ = {A}_{G} ( {f}_{x} , {f}_{y} ) + {jB}_{G} ( {f}_{x} , {f}_{y} )\end{matrix} & ( 8 )\end{matrix}$$

In step S235, the alternating component detection units 32A and 32B detect alternating components from the outputs of the Fourier transform units 31A and 31B, respectively. In step S236, the determination units 33A and 33B determine whether the values of the alternating components detected in step S235 are equal to or larger than a threshold value that has been set in advance. If the values of the alternating components are not equal to or larger than the threshold value, each of the determination units 33A and 33B determines that a frame being processed is not a scene change in step S252. In step S253, the determination units 33A and 33B determine whether all frames have already been subjected to detection processing. If all frames have not yet been subjected to detection processing, the process returns to step S231 and the process from step S231 to the subsequent steps is repeatedly performed.

If it is determined in step S236 that the values of the alternating components are equal to or larger than the threshold value, the amplitude spectrum computation units 311A and 311B compute amplitude spectrums of the outputs of the Fourier transform units 31A and 31B, respectively. More specifically, the following equations (9) and (10) are computed.

P_{F}(fₓ,f_{y})=\sqrt{A_{F}(fₓ,f_{y})²+B_{F}(fₓ,f_{y})²} (9)

P_{G}(fₓ,f_{y})=\sqrt{A_{G}(fₓ,f_{y})²+B_{G}(fₓ,f_{y})²} (10)

Next, in step S238, the log-polar coordinate transformation units 312A and 312B transform the outputs of the amplitude spectrum computation units 311A and 311B into log-power coordinates, respectively. More specifically, equations (9) and (10) are transformed into P_{F} (ρ, θ) and P_{G} (ρ, θ) using the following equations (11) and (12).

x=ρ cos(θ) (11)

y=ρ sin(θ) (12)

In step S239, the Fourier transform units 331A and 331B perform two-dimensional fast Fourier transforms upon the outputs of the log-polar coordinate transformation units 312A and 312B, respectively. More specifically, the following equations (13) and (14) are computed.

$$\begin{matrix}F ( {f}_{ρ} , {f}_{θ} ) = {\int }_{- ∞}^{+ ∞} {\int }_{- ∞}^{+ ∞} f ( ρ , θ ) {e}^{- 2 π j ( {f}_{ρ} ρ + {f}_{θ} θ )} d ρ d θ & ( 13 ) \\ G ( {f}_{ρ} , {f}_{θ} ) = {\int }_{- ∞}^{+ ∞} {\int }_{- ∞}^{+ ∞} g ( ρ , θ ) {e}^{- 2 π j ( {f}_{ρ} ρ + {f}_{θ} θ )} d ρ d θ & ( 14 )\end{matrix}$$

In step S240, the cross power spectrum detection unit 332 detects a cross power spectrum using the outputs of the Fourier transform units 331A and 331B. That is, one of the following equations (15) and (16) is computed.

$$\begin{matrix}S ( {f}_{ρ} , {f}_{θ} ) = \frac{F ( {f}_{ρ} , {f}_{θ} )}{\vert F ( {f}_{ρ} , {f}_{θ} ) \vert} \frac{G * ( {f}_{ρ} , {f}_{θ} )}{\vert G ( {f}_{ρ} , {f}_{θ} ) \vert} & ( 15 ) \\ S ( {f}_{ρ} , {f}_{θ} ) = \frac{F ( {f}_{ρ} , {f}_{θ} ) G * ( {f}_{ρ} , {f}_{θ} )}{\vert F ( {f}_{ρ} , {f}_{θ} ) G * ( {f}_{ρ} , {f}_{θ} ) \vert} & ( 16 )\end{matrix}$$

In step S241, the inverse Fourier transform unit 333 performs a two-dimensional fast inverse Fourier transform upon the cross power spectrum output from the cross power spectrum detection unit 332. More specifically, the following equation (17) is computed.

$$s ( ρ , θ ) = {\int }_{- ∞}^{+ ∞} {\int }_{- ∞}^{+ ∞} S ( {f}_{ρ} , {f}_{θ} ) {e}^{2 π j ( {f}_{ρ} ρ + {f}_{θ} θ )} d {f}_{ρ} d {f}_{θ} \qquad ( 17 )$$

In step S242, the rotation/scaling detection section 303 calculates a scaling ratio and a rotation angle from a signal output from the inverse Fourier transform unit 333. In the output of the inverse Fourier transform unit 333, ρ denotes a scaling ratio, and θ denotes a rotation angle. In step S243, the rotation/scaling transformation section 304 performs scaling and rotation control upon the signal transmitted from the Fourier transform unit 31B on the basis of the scaling ratio ρ and the rotation angle θ which have been transmitted from the rotation/scaling detection section 303. Consequently, the scaling and rotation of the output of the Fourier transform unit 31B is controlled so as to correspond to the output of the Fourier transform unit 31A.

In step S244, the Fourier transform unit 341 performs a Fourier transform upon the output of the rotation/scaling transformation section 304. In step S245, the cross power spectrum detection unit 51 detects a cross power spectrum using signals transmitted from the Fourier transform unit 31A and the Fourier transform unit 341. In step S246, the inverse Fourier transform unit 52 performs a two-dimensional fast inverse Fourier transform upon the cross power spectrum output from the cross power spectrum detection unit 51.

In step S247, the normalization section 16 normalizes the output of the inverse Fourier transform unit 52. That is, the following equation (18) is computed.

$$p ( ρ , θ ) = \frac{\vert s ( ρ , θ ) \vert}{max ( \vert s ( ρ , θ ) \vert )} \qquad ( 18 )$$

In step S248, the counter section 17 counts the number of amplitudes having a value equal to or larger than a threshold value. In step S249, the determination section 18 determines whether the value counted in step S248 is equal to or larger than a threshold value that has been set in advance. If the counted value is not equal to or larger than the threshold value, the determination section 18 determines that one of the frames being processed is not a scene change in step S252. Subsequently, in step S253, the determination section 18 determines whether all frames have already been subjected to detection processing. If all frames have not yet been subjected to detection processing, the process returns to step S231 and the process from step S231 to the subsequent steps is repeatedly performed.

If it is determined in step S249 that the counted value is equal to or larger than the threshold value, the determination section 18 determines that one of the frames being processed is a scene change. Subsequently, in step S251, the storage section 19 stores the determination result. In step S253, the determination section 18 determines whether all frames have already been subjected to detection processing. If all frames have not yet been subjected to detection processing, the process returns to step S231. If it is determined that all frames have already been subjected to detection processing, the scene change detection ends.

Thus, since scaling or a rotation angle of an image is controlled, the image processing apparatus shown in FIG. 29 can more accurately detect a scene change without being affected by the rotation angle or scaling of the image.

FIG. 32 shows a configuration of an image processing apparatus according to another embodiment of the present invention which is used to detect a scene change by performing computation except for computation compliant with SPOMF. In this image processing apparatus, a computation section 351A processes a signal that has been processed by the image input section 11A, the region extraction section 12A, and the image reducing section 13A. Similarly, a computation section 351B processes a signal that has been processed by the image input section 11B, the region extraction section 12B, and the image reducing section 13B. The computation section 351A is provided with the average computation unit 361A and the difference computation unit 362A. Similarly, the computation section 351B is provided with the average computation unit 361B and the difference computation unit 362B.

The average computation units 361A and 361B perform computation of an average for the outputs of the image reducing sections 13A and 13B, respectively. The difference computation units 362A and 362B compute differences between the outputs of the image reducing sections 13A and 13B and the outputs of the average computation units 361A and 361B, respectively.

A computation section 352 performs computation upon the outputs of the difference computation units 362A and 362B. The computation section 352 is provided with the matching unit 371 and a multiplying unit 372. The matching unit 371 computes the sum of absolute differences of outputs of the difference computation units 362A and 362B. The multiplying unit 372 multiplies the sum of absolute differences computed by the matching unit 371 by −1.

Like the above-described cases, the output of the computation section 352 is processed by the normalization section 16, the counter section 17, the determination section 18, and the storage section 19.

Next, scene change detection performed by the image processing apparatus shown in FIG. 32 will be described with reference to flowcharts shown in FIGS. 33 and 34.

In step S301, the image input sections 11A and 11B receive images forming different frames. In step S302, the region extraction sections 12A and 12B extract image signals corresponding to predetermined regions of the images represented by image signals transmitted from the image input sections 11A and 11B, respectively. In step S303, the image reducing sections 13A and 13B reduce the sizes of the regions represented by the image signals extracted by the region extraction sections 12A and 12B, respectively.

In step S304, the average computation unit 361A perform computation of an average for a single image corresponding to a size-reduced image represented by the image signal transmitted from the image reducing section 13A. Similarly, the average computation unit 361B perform computation of an average for a single image corresponding to a size-reduced image represented by the image signal transmitted from the image reducing section 13B. These average values are represented by avg(f(x, y)) and avg(g(x, y)), respectively.

In step S305, the difference computation units 362A and 362B compute differences between the outputs of the image reducing sections 13A and 13B and the outputs of the average computation units 361A and 361B, respectively. More specifically, the following equations (19) and (20) are computed. In the following equations, a variable to which the symbol “′” is added is different from a variable to which the symbol is not added.

f′(x,y)=f(x,y)−avg(f(x,y)) (19)

g′(x,y)=g(x,y)−avg(g(x,y)) (20)

In step S306, the matching unit 371 calculates the sum of absolute differences of outputs of the difference computation units 362A and 362B. More specifically, the following equation (21) is computed. In step S307, the multiplying unit 372 multiplies the sum of absolute differences calculated by the matching unit 371 by −1. That is, the following equation (22) is computed.

$$\begin{matrix}s ( i , j ) = {\sum }_{{y}^{′} = 1 + n}^{max ( y ) - n} {\sum }_{{x}^{′} = 1 + m}^{max ( x ) - m} \vert {f}^{′} ( {x}^{′} , {y}^{′} ) - {g}^{′} ( {x}^{′} + i , {y}^{′} + j ) \vert & ( 21 ) \\ {s}^{′} ( x , y ) = - s ( x , y ) & ( 22 )\end{matrix}$$

In step S308, the normalization section 16 normalizes the output of the multiplying unit 372. More specifically, the following equation (23) is computed.

$$p ( x , y ) = \frac{{s}^{′} ( x , y )}{max ( {s}^{′} ( x , y ) )} \qquad ( 23 )$$

In step S309, the counter section 17 counts the number of amplitudes having a value equal to or larger than a threshold value. In step S310, the determination section 18 determines whether the value counted in step S309 is equal to or larger than a threshold value. If the counted value is not equal to or larger than the threshold value, the determination section 18 determines that one of the frames being processed is not a scene change in step S313. Subsequently, in step S314, the determination section 18 determines whether all frames have already been subjected to detection processing. If all frames have not yet been subjected to detection processing, the process returns to step S301 and the process from step 301 to the subsequent steps is repeatedly performed.

If it is determined in step S310 that the counted value is equal to or larger than the threshold value, the determination section 18 determines that one of the frames being processed is a scene change in step S311. In step S312, the storage section 19 stores the result of the determination performed in step S311. In step S314, the determination section 18 determines whether all frames have already been subjected to detection processing. If all frames have not yet been subjected to detection processing, the process returns to step S301 and the process from step S301 to the subsequent steps is repeatedly performed. If it is determined that all frames have already been subjected to detection processing, the scene change detection ends.

In this image processing apparatus, a non-image detection section, a simplified detection section, a dividing section, or a representative image detection section may be added.

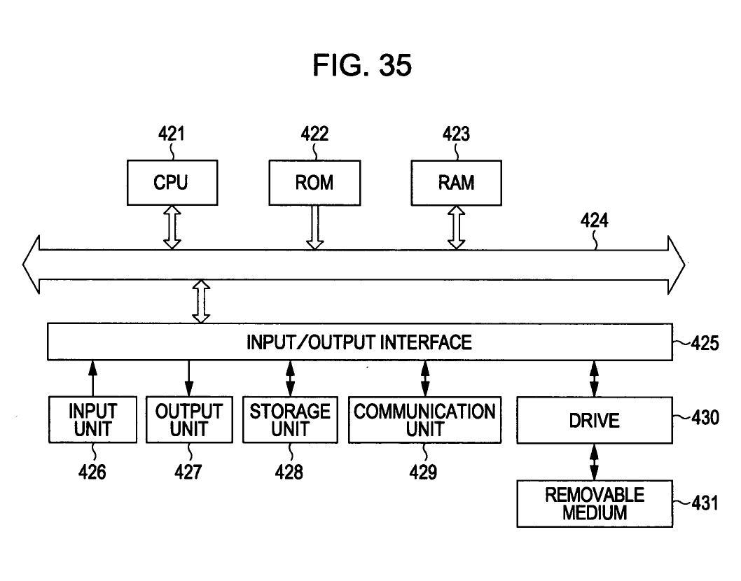

FIG. 35 is a block diagram showing an exemplary configuration of a personal computer that performs the above-described processing flow using a program. A CPU (Central Processing Unit) 421 performs various processing operations in accordance with a program stored in a ROM (Read-Only Memory) 422 or a storage unit 428. A RAM (Random Access Memory) 423 stores a program to be executed by the CPU 421 and data as appropriate. The CPU 421, the ROM 422, and the RAM 423 are connected to each other via a bus 424.

The CPU 421 is also connected to an input/output interface 425 via the bus 424. The input/output interface 425 is connected to an input unit 426 configured with a keyboard, a mouse, and a microphone, and an output unit 427 configured with a display and a speaker. The CPU 421 performs various processing operations in accordance with instructions input from the input unit 426, and outputs the result of processing to the output unit 427.

The storage unit 428 connected to the input/output interface 425 is configured with, for example, a hard disk, and stores a program to be executed by the CPU 421 and various pieces of data. A communication unit 429 communicates with an external apparatus via a network such as the Internet or a local area network. A program may be acquired via the communication unit 429 and may be stored in the storage unit 428.

When a removable medium 431 such as a magnetic disk, an optical disc, a magneto-optical disk, or a semiconductor memory is attached to a drive 430 connected to the input/output interface 425, the drive 430 drives the removable medium 431 to acquire a program or data recorded thereon. The acquired program or data is transferred to the storage unit 428 as appropriate, and is then recorded in the storage unit 428.

If the processing flow is performed by software, a program configuring the software is installed from a program recording medium on a computer embedded in a piece of dedicated hardware or, for example, on a general-purpose personal computer that is allowed to perform various functions by installing various programs thereon.

As shown in FIG. 35, the program recording medium storing the program to be installed on the computer and to be executed by the computer includes: the removable medium 431 that is a package medium such as a magnetic disk (including a flexible disk), an optical disc (including a CD-ROM (Compact Disc-Read-Only Memory), a DVD (Digital Versatile Disc), and a magneto-optical disk), or a semiconductor memory; the ROM 422 in which the program is temporarily or permanently stored; and the hard disk configuring the storage unit 428. The storage of the program on the program recording medium is performed via the communication unit 429 that is an interface such as a router or a modem using a wired or wireless communication medium such as a local area network, the Internet, or digital satellite broadcasting as appropriate.

In this description, the steps describing the program to be stored in the program recording medium do not have to be executed in chronological order described above. The steps may be concurrently or individually.

In this description, a system denotes an entire apparatus composed of a plurality of devices.

It should be understood by those skilled in the art that various modifications, combinations, sub-combinations and alterations may occur depending on design requirements and other factors insofar as they are within the scope of the appended claims or the equivalents thereof.

What is claimed is:

1. An image processing apparatus comprising:
a correlation computation unit configured to compute a phase correlation between image signals forming a plurality of images; and
a detection unit configured to detect a scene change on the basis of values of amplitudes in coordinate positions on the plurality of images, the values of amplitudes being obtained by computing the phase correlation.

2. The image processing apparatus according to claim 1, wherein the correlation computation unit performs computation compliant with SPOMF.

3. The image processing apparatus according to claim 2, wherein the correlation computation unit includes:
a Fourier transform unit configured to perform Fourier transforms upon the image signals forming the plurality of images;
a cross power spectrum computation unit configured to compute a cross power spectrum using values obtained by performing the Fourier transforms; and
an inverse Fourier transform unit configured to perform an inverse Fourier transform upon the computed cross power spectrum.

4. The image processing apparatus according to claim 1, wherein the detection unit includes:
a counter unit configured to count the number of amplitudes; and
a determination unit configured to perform determination of a scene change if the number of amplitudes is larger than a reference value.

5. The image processing apparatus according to claim 4,
wherein the detection unit further includes a normalization unit configured to normalize the values of amplitudes, and
wherein the counter unit counts the number of normalized amplitudes.

6. The image processing apparatus according to claim 1, further comprising an extraction unit configured to extract image signals corresponding to regions that are portions of the plurality of images from the image signals forming the plurality of images, and
wherein the correlation computation unit computes a phase correlation between the extracted image signals corresponding to the regions.

7. The image processing apparatus according to claim 6, further comprising a reducing unit configured to generate image signals by reducing sizes of the regions that are portions of the extracted image signals, and
wherein the correlation computation unit computes a phase correlation between the generated image signals corresponding to the size-reduced regions.

8. The image processing apparatus according to claim 1, further comprising a non-image detection unit configured to detect image signals forming non-images from the image signals forming the plurality of images, and
wherein the correlation computation unit performs computation if the image signals forming the plurality of images are not image signals forming non-images.

9. The image processing apparatus according to claim 8, wherein the non-image detection unit includes:
a Fourier transform unit configured to perform Fourier transforms upon the image signals forming the plurality of images;
an alternating component detection unit configured to detect alternating components from the Fourier-transformed image signals; and
a control unit configured to interrupt computation of the correlation computation unit when values of the detected alternating components are smaller than an alternating component threshold value.

10. The image processing apparatus according to claim 9, further comprising a difference computation unit configured to compute a difference between the image signals forming the plurality of images, and
wherein the correlation computation unit performs computation when the computed difference is larger than a difference threshold value.

11. The image processing apparatus according to claim 1, further comprising a dividing unit configured to divide each of the image signals forming the plurality of images so as to generate image signals corresponding to portions obtained by dividing a single image into the portions, and
wherein the correlation computation unit computes phase correlations between corresponding image signals generated by dividing each of the image signals forming the plurality of images.

12. The image processing apparatus according to claim 1, further comprising a representative image detection unit configured to detect a representative image using a result of computation performed by the correlation computation unit.

13. The image processing apparatus according to claim 12, wherein the representative image detection unit detects an image corresponding to a motion vector having the minimum value as a representative image, the motion vector being obtained as a result of commutation performed by the correlation computation unit.

14. The image processing apparatus according to claim 1, further comprising:
a Fourier transform unit configured to perform Fourier transforms upon the image signals forming the plurality of images;
an amplitude spectrum computation unit configured to compute amplitude spectrums of the Fourier-transformed image signals;
a coordinate transformation unit configured to transform the amplitude spectrums into log-polar coordinates; and
a transformation unit configured to compute a phase correlation between signals obtained by the log-polar coordinate transformation, and perform transformation processing for image rotation or image scaling on the basis of the computed phase correlation, and
wherein the correlation computation unit computes a phase correlation using an image signal obtained by performing the transformation processing.

15. An image processing method comprising the steps of:
computing a phase correlation between image signals forming a plurality of images; and
detecting a scene change on the basis of values of amplitudes in coordinate positions on the plurality of images, the values of amplitudes being obtained by computing the phase correlation.

16. A program causing a computer to perform the steps of:
computing a phase correlation between image signals forming a plurality of images; and
detecting a scene change on the basis of values of amplitudes in coordinate positions on the plurality of images, the values of amplitudes being obtained by computing the phase correlation.

17. A recording medium recording the program according to claim 16.

18. An image processing apparatus comprising:
an average computation unit configured to compute an average for each of image signals forming a plurality of images;
a difference computation unit configured to compute differences between values of the image signals forming the plurality of images and the computed corresponding averages;
a matching unit configured to perform matching of the computed differences; and
a detection unit configured to detect a scene change on the basis of values of amplitudes in coordinate positions on the plurality of images, the values of amplitudes being obtained by performing the matching.

19. The image processing apparatus according to claim 18, further comprising an extraction unit configured to extract image signals corresponding to regions that are portions of the plurality of images from the image signals forming the plurality of images, and
wherein the average computation unit computes the average for each of the extracted image signals corresponding to the regions.

20. The image processing apparatus according to claim 19, further comprising a reducing unit configured to generate image signals by reducing sizes of the regions that are portions of the extracted image signals, and
wherein the average computation unit computes the average for each of the generated image signals corresponding to the size-reduced regions.

21. An image processing method comprising the steps of:
computing an average for each of image signals forming a plurality of images;
computing differences between values of the image signals forming the plurality of images and the computed corresponding averages;
performing matching of the computed differences; and
detecting a scene change on the basis of values of amplitudes in coordinate positions on the plurality of images, the values of amplitudes being obtained by performing the matching.

22. A program causing a computer to perform the steps of:
computing an average for each of image signals forming a plurality of images;
computing differences between values of the image signals forming the plurality of images and the computed corresponding averages;
performing matching of the computed differences; and
detecting a scene change on the basis of values of amplitudes in coordinate positions on the plurality of images, the values of amplitudes being obtained by performing the matching.

23. A recording medium recording the program according to claim 22.
